(19) United States
(12) Patent Application Publication
(10) Pub. No.: US 2022/0149459 A1
(43) Pub. Date: May 12, 2022

(54) AQUEOUS ELECTROCHEMICAL ENERGY STORAGE DEVICES AND COMPONENTS

(71) Applicant: Sila Nanotechnologies, Inc., Alameda, CA (US)

(72) Inventors: Gleb YUSHIN, Atlanta, GA (US); Bogdan ZDYRKO, Atlanta, GA (US); Eugene Michael BERDICHEVSKY, Alameda, CA (US)

(21) Appl. No.: 17/648,581

(22) Filed: Jan. 21, 2022

Related U.S. Application Data
(63) Continuation of application No. 14/699,573, filed on Apr. 29, 2015, now abandoned.
(60) Provisional application No. 61/986,982, filed on May 1, 2014.

(51) Int. Cl. H01M 12/00; H01M 10/28; H01M 4/62; H01M 10/36; H01M 4/36; H01G 11/04

(52) U.S. Cl. CPC H01M 12/00; H01M 10/28; H01M 4/628; H01M 10/36; H01M 10/24; H01G 11/04; H01M 2300/0005; H01M 4/62; H01M 4/366

(57) ABSTRACT

Battery electrode compositions are provided for use in aqueous electrolytes and may comprise, for example, a current collector, active particles, and a conformal, metal-ion permeable coating. The active particles may be electrically connected to the current collector, and provided to store and release metal ions of an active material during battery operation. The conformal, metal-ion permeable coating may at least partially encase the surface of the connected active particles, whereby the conformal, metal-ion permeable coating impedes (i) direct electrical contact of an aqueous electrolyte with the active particles and (ii) aqueous electrolyte decomposition during battery operation. Such electrode compositions and corresponding aqueous batteries may facilitate the incorporation of advanced material synthesis and electrode fabrication technologies, and enable fabrication of high voltage and high capacity aqueous batteries at a cost lower than that of conventional metal-ion battery technology.

### CLAIM OF PRIORITY

The present application for patent is a Continuation of U.S. Non-Provisional application Ser. No. 14/699,573, entitled “Aqueous Electrochemical Energy Storage Devices and Components,” filed Apr. 29, 2015, which claims the benefit of U.S. Provisional Application No. 61/986,982, entitled “Aqueous Electrochemical Energy Storage Devices and Components,” filed May 1, 2014, each of which is expressly incorporated herein by reference in its entirety.

### BACKGROUND

### Field

The present disclosure relates generally to energy storage devices, and more particularly to aqueous battery technology and the like.

### Background

Among the metal-ion batteries, Li-ion battery technology has achieved the greatest commercial success, owing to the very high gravimetric capacity (3860 mAh/g) and moderately high volumetric capacity (2061 Ah/L) of Li anodes combined with the high activity of Li and the high mobility of Li ions in various hosts.

Yet, other metal-ion batteries (such as K-ion, Ca-ion, Na-ion, Mg-ion, Al-ion, to name a few) may also offer reasonably high volumetric and gravimetric energy densities.

Unfortunately, current Li-ion battery technology utilized for transportation, grid storage, and electronic device fields is expensive, slow, and unsafe. Such cells utilize organic electrolytes and suffer from several limitations. Formation of Li dendrites in commercial batteries is particularly challenging to detect and prevent. When formed, they may lead to internal shorts, which give rise to local heating, melting of the separator, thermal runaway, and eventually fire. The high flammability of organic electrolytes does not help this situation. In addition, decomposition of organic electrolytes with the presence of water and other impurities limit the cycle life of Li-ion batteries and make their assembling expensive. Further, the relatively low ionic conductivity of organic electrolytes combined with the low ionic conductivity of the solid electrolyte interphase (SEI) induced by the reduction of the organic electrolyte limits the power performance of Li-ion batteries.

Aqueous alkaline batteries (for example, those based on a Zn anode and a MnO₂ cathode) offer improved safety and reduced cost, but suffer from very short cycle life and limited energy density.

The use of aqueous chemistry may significantly improve the safety of Li-ion battery technologies, and, at the same time, reduce the cost of Li-ion cells and corresponding battery packs. However, the use of aqueous electrolytes is known to typically limit the maximum voltage of aqueous Li-ion and other metal-ion batteries to below around 1.2-1.5V. This low voltage limits the energy density of the cells. In addition, the electrode fabrication and cell construction developed for conventional Li-ion chemistry utilizing organic electrolytes is very expensive. Adoption of similar manufacturing technology for aqueous Li-ion cells will increase their manufacturing cost.

Accordingly, there remains a need for improved aqueous metal-ion batteries, components, and other related materials and manufacturing processes. Similarly, there remains a need for aqueous alkaline batteries with long cycle life and increased energy density.

### SUMMARY

Embodiments disclosed herein address the above stated needs by providing improved aqueous battery components, improved batteries made therefrom, and methods of making and using the same. Such aqueous batteries facilitate the incorporation of advanced material synthesis and electrode fabrication technologies, and enable fabrication of high voltage and high capacity aqueous batteries at a cost lower than that of conventional Li-ion battery technology.

As an example, a battery electrode composition for use in aqueous electrolytes as described herein may comprise, for example, a current collector, active particles, and a conformal, metal-ion permeable coating. The active particles may be electrically connected to the current collector, and provided to store and release metal ions of an active material during battery operation. The conformal, metal-ion permeable coating may at least partially encase the surface of the connected active particles, whereby the conformal, metal-ion permeable coating impedes (i) direct electrical contact of an aqueous electrolyte with the active particles and (ii) aqueous electrolyte decomposition during battery operation.

In some designs, the aqueous electrolyte may be a pH-neutral aqueous solution of a Li-based salt. In addition or as an alternative, the aqueous electrolyte may be a pH-neutral aqueous solution of a Na-based salt. In addition or as an alternative, the aqueous electrolyte may be a pH-basic aqueous solution with having a pH greater than 9. In addition or as an alternative, the aqueous electrolyte may comprise a total salt concentration of at least of 3 molar.

In some designs, the active particles may comprise composite particles having an inner core and an outer shell. The core, the shell, or both the core and the shell of the active particles may be a nanocomposite, for example. The core, the shell, or both the core and the shell of the active particles may also be formed with a radially changing composition, porosity, or average pore size from the center to the perimeter of each composite particle. As an example, the shell may comprise Sn, Ti, Ta, Tl, Pb, Cd, Zn, Sb, or Bi.

In some designs, the conformal, metal-ion permeable coating may comprise an inner layer and an outer layer. The inner layer may comprise, for example, a material selected and arranged to: electrically interconnect the active particles; promote uniformity of the outer layer; enhance mechanical stability of the coating; protect the active material against dissolution or other reactions with the aqueous electrolyte; or impede decomposition of the aqueous electrolyte.

In some designs, the battery electrode composition may further comprise an aqueous electrolyte additive configured to decompose into the coating in response to application of an electrical potential below the decomposition potential of water. The aqueous electrolyte may comprise, for example, a salt of a superacid; a mixture of a salt of a superacid and a salt of another acid; a mixture of a salt of an organic acid and a salt of an inorganic acids; or a mixture of a salt with a surfactant.

In some designs, the battery electrode composition may further comprise a pH-regulating functional group. The pH-regulating functional group may be, for example, a polymeric pH-regulating functional group.

A battery is also provided that comprises anode and cathode electrodes, as well as an aqueous electrolyte. At least one of the anode or the cathode electrodes may comprise a battery electrode composition of the type described above or elsewhere herein. The aqueous electrolyte may ionically couple the anode and the cathode.

A method of fabricating an aqueous metal-ion battery electrode composition is also proved. The method may comprise, for example, providing active particles to store and release metal ions of an active material during battery operation; electrically connecting the active particles with a current collector; and forming a conformal, metal-ion permeable so as to at least partially encase the surface of the connected active particles.

In some designs, the forming may comprise, for example, providing an aqueous electrolyte additive; and applying an electrical potential to induce decomposition of the aqueous electrolyte additive into the coating at the potential, wherein the current corresponding to the electrochemical process of water decomposition is below 10% of the total current involved in the additive decomposition.

In some designs, the method may further comprise, for example, filling the electrode with an electrolyte polymer bearing one or more pH-regulating functional groups for impeding water decomposition during battery operation.

In some designs, the current collector may comprise, for example, 1% to 99.999% of Sn, Ti, Ta, Tl, Pb, Cu, Cd, Zn, Sb, or Bi. In addition or as an alternative, the current collector may comprise, for example, metal wires or nanowires; metal flakes; a conformal metal coating; or a porous metal foil.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a stability profile for water (H₂O) across pH.

FIG. 2 illustrates an electrochemical cell design for localizing pH at the electrodes to enhance the aqueous electrolyte stability voltage range.

FIG. 3A provides examples of pH modifying units located in the polymeric electrolyte additives and aqueous electrolyte salts that largely do not exhibit unfavorable interactions with the polymer electrolytes and thus may be used in conjunction with the cell design of FIG. 2.

FIG. 3B provides examples of synthesis of suitable pH modifying polymers, described in FIG. 3A.

FIG. 4 provides two graphs illustrating the impact of pH-regulating coatings on the electrochemical stability of a pH-neutral aqueous electrolyte.

FIG. 5 illustrates a method of aqueous battery fabrication, where the electrolyte comprises salts of superacids as described herein.

FIG. 6 illustrates a method of aqueous Li-ion (or other metal-ion such as Na-ion) battery fabrication, where the electrolyte comprises a mixture of Li (or Na, etc.) salts with the salt(s) of other species as described herein.

FIG. 7 illustrates a method of aqueous Li-ion (or other metal-ion such as Na-ion) battery fabrication, where the electrolyte comprises a ternary or quaternary mixture of salts as described herein.

FIG. 8 illustrates a method of aqueous Li-ion (or other metal-ion such as Na-ion) battery fabrication, where the electrolyte comprises a mixture of organic and inorganic salts as described herein.

FIG. 9 illustrates a method of aqueous Li-ion (or other metal-ion such as Na-ion) battery fabrication, where the electrolyte comprises suitable surfactants as described herein.

FIGS. 10A-10F provide examples of different current collectors and electrodes comprising such current collectors.

FIGS. 11A-11C are flow charts illustrating example methods of fabricating a battery electrode composition comprising active particles.

FIG. 12 is a cross-sectional view of an electrode illustrating the use of an electrically insulative but ionicially conductive conformal coating.

FIG. 13 illustrates the voltage drop between the anode and the cathode of an aqueous cell with and without a protective coating.

FIG. 14 illustrates the voltage drop between the anode and the cathode of an aqueous cell with a protective coating on the cathode only.

FIGS. 15-17 are schematic illustrations of different examples of in-situ formation of the protective coating layer on an electrode via different suitable precursors.

FIG. 18 illustrates an example multi-layer implementation of the protective coating layer impeding aqueous electrolyte decomposition.

FIG. 19 is a cross-sectional view of electrode components, illustrating the use of coatings that induce over-potential for water decomposition.

FIG. 20 provides cross-sectional views of different particle designs, incorporating one or more Li-ion permeable, but solvent impermeable protective shell(s) and, in this example, various Metal Sulfides as the active material.

FIG. 21 provides an example of a high capacity aqueous Li-ion battery with a pH-modified anode and cathode.

FIG. 22 provides an example of a high capacity aqueous Li-ion battery with electrodes comprising a functional coating, that substantially reduces water decomposition by either inducing an overpotential for hydrogen generation on the anode (or oxygen generation at the cathode) or by serving as an electrically insulating layer, or both.

FIG. 23 provides an example of different porous particle designs containing a conversion-type active material (such as sulfur in this example) that experiences volume changes upon Li insertion.

FIG. 24 provides an example of different porous particle designs containing a conversion-type active material (such as metal fluoride) that experiences volume changes upon Li insertion.

FIG. 25 provides an example of different porous particle designs containing a conversion-type active material (such as iron, cadmium, zinc, and others) that experiences volume changes upon electrochemical oxidation.

FIG. 26 is a flow chart illustrating an example method of fabricating an aqueous battery as described herein.

FIG. 27 shows a comparison of capacity, voltage, and energy characteristics of two cell constructions, including a conventional Li-ion cell side by side with an aqueous Li-ion cell.

FIG. 28 shows a “Russian Doll” battery configuration of an aqueous Li-ion cell or an aqueous hybrid Li-ion/alkaline cell as described herein.

FIG. 29 shows a comparison of two cell constructions, including a conventional Li-ion cell side by side with an aqueous Li-ion cell or an aqueous hybrid Li-ion/alkaline cell as described herein.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

Aqueous metal-ion (such as Li-ion) technology may offer enhanced safety, enhanced power performance and reduced cost compared to traditional Li-ion technology that utilizes organic electrolyte(s). Organic electrolytes used in conventional Li-ion batteries exhibit specific Li-ion conductance of up to about 3 mS/cm. In contrast, Li ions in aqueous solutions exhibit conductance of about 75 mS/cm. Thus, for the same electrodes and current rate, organic electrolytes may induce about a twenty-five times higher polarization. Therefore, Li-ion battery cells with aqueous electrolyte(s) may operate at more than an order of magnitude higher current densities and accordingly provide an order of magnitude higher power. Conversely, for the same power performance, aqueous Li-ion batteries may utilize thicker electrodes.

The key bottlenecks in the development of stable, low-cost, aqueous Li-ion technology, however, include: (i) a low thermodynamically stable voltage range for aqueous electrolytes; (ii) the absence of stable electrode materials that offer high capacity; and (iii) high cost and poor compatibility of traditional Li-ion cell manufacturing techniques with aqueous Li-ion technologies.

The improvements in aqueous Li-ion battery technology described herein address the above-noted challenges, and may be implemented via one or more of several complimentary techniques, including but not limited to: (1) different techniques for increasing the voltage stability range of pH-neutral aqueous electrolytes, such as (1.a) forming ion-permeable coatings on the electrode surface prior to or after cell assembly and/or (1.b) filling at least one of the electrodes with a pH-regulating polymer electrolyte, with the techniques impeding water decomposition as well as the resulting gas generation (e.g., H₂ generation on the anode or CO₂ or O₂ generation on the cathode) and self-discharge; (2) different techniques for increasing the voltage stability range of basic aqueous electrolytes (for example, aqueous solution of LiOH), such as forming (2.a) ion-permeable coatings on the electrode surface, that impede aqueous electrolyte decomposition as well as the resulting gas generation and self-discharge or (2.b) coatings that induce over-potential for water decomposition; (3) different techniques for reducing the cost of electrode fabrication and aqueous cell assembling; (4) different techniques for forming advanced nanostructured high-capacity electrodes compatible with aqueous chemistry; (5) different recipes of selecting the electrolyte composition(s), coating composition(s) and current collector composition(s) that allow for greatly reduced water decomposition and long-term stability of the high voltage (e.g., anywhere within 1.5-5 V voltage range) aqueous cell(s).

A hybrid Li-ion/alkaline battery technology is further disclosed to offer a complimentary approach to a conventional aqueous Li-ion battery chemistry, where a Li-ion hosting cathode is the same as in a regular aqueous Li-ion cell, but a Li-ion hosting anode is substituted with, for example, a metal anode that interacts with hydroxide anions (OH⁻) of alkaline electrolyte (such as a LiOH-comprising aqueous solution), forming, for example, a metal hydroxide or a metal oxide during cell discharge. Such hybrid battery technology similarly benefits from various techniques of protective coating formation (on the surface of each electrode) that impede aqueous alkaline electrolyte decomposition as well as the resulting gas generation and self-discharge.

In the description below, several examples are provided in the context of aqueous Li-ion batteries because of the current prevalence and popularity of Li-ion technology. However, it will be appreciated that such examples are provided merely to aid in the understanding and illustration of the underlying techniques, and that these techniques may be similarly applied to various other metal-ion batteries, such as aqueous Na-ion, aqueous Ca-ion, aqueous K-ion, aqueous Mg-ion, and other aqueous metal-ion batteries.

Similarly, the disclosed hybrid Li-ion/alkaline battery technology may be similarly applied to various other hybrid metal-ion/alkaline battery chemistries, such as K-ion/alkaline hybrid chemistries, Na-ion/alkaline hybrid chemistries, Ca-ion/alkaline hybrid chemistries and Mg-ion/alkaline hybrid chemistries, to name a few.

In the description below, several examples are also provided in the context of pH-neutral aqueous Li-ion batteries. Again, however, it will be appreciated that such examples are provided merely to aid in understanding and that some deviations from absolute pH neutrality (such as a pH ranging from 4 to 9) may generally be acceptable for aqueous Li-ion batteries, which are still termed herein “pH-neutral”.

In addition, various aspects of the present disclosure may be applied to various aqueous electrochemical capacitors, aqueous pseudocapacitors, aqueous Li-ion capacitors, aqueous asymmetric supercapacitors, hybrid electrochemical capacitor-battery devices (where one of the electrodes is battery-like, while the other is electrochemical capacitor-like), and other aqueous electrochemical energy storage devices in order to enhance their performance (for example, to enhance maximum charge voltage or to reduce leakage current, or both). Further, various aspects of the present disclosure may also be applied to various devices where only one of the electrodes is exposed to pH-neutral aqueous electrolyte, to electrochemical energy storage devices based on non-aqueous electrolytes, or to non-pH-neutral aqueous electrolytes.

According to different embodiments, various aspects of the present disclosure may be applied to both the positive electrode and the negative electrode of aqueous electrochemical energy storage devices, or to the electrodes individually (either the positive electrode or the negative electrode). Application to only one of the electrodes may be used to prevent aqueous electrolyte decomposition on such an electrode. For example, application to a cathode in particular may help prevent oxygen evolution at higher potentials. Application to an anode in particular may help prevent hydrogen evolution at lower potentials.

Several methods are described below to enhance the aqueous electrolyte stability voltage range. For example, in a first method, a surface modification of at least one of the electrodes may be utilized. For example, a pH modification of the electrode may be implemented. This may be particularly beneficial for pH-neutral aqueous electrolytes. In another method, a conformal coating may be formed on the electrode surface to account for some of the voltage drop between the electrodes, allowing liquid electrolyte to be maintained within a stable potential range. In yet another method, a conformal coating may be formed on the electrode surface that induces a large over-potential for water decomposition reaction(s). The last two methods may be generally applied to both pH-neutral aqueous electrolytes and aqueous electrolytes that are not pH-neutral.

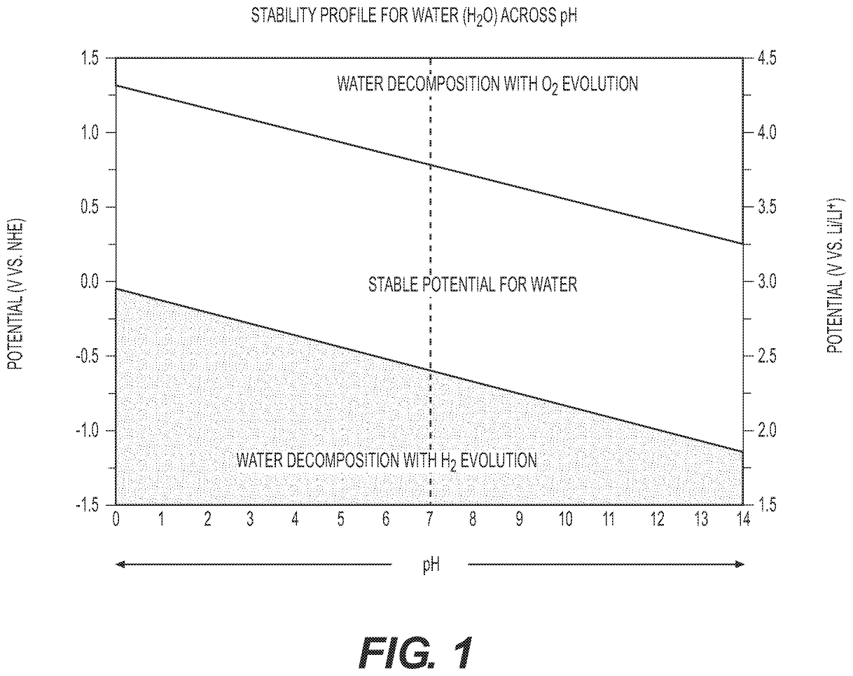

FIG. 1 illustrates a stability profile for water (H₂O) across pH. As shown, at high potentials, H₂O decomposes with O₂ evolution, and at low potentials, with H₂ evolution. The potential of H₂O oxidation at the cathode, 2H₂O→O₂(g)+4H⁺+2e⁻, is governed by the Nernst equation and can be increased to above 1.2 V (vs. NHE) at low pH values. Similarly, the potential of H₂O reduction at the anode, 2H⁺+2e⁻→H₂(g) or H₂O+2e⁻→H₂(g)+2OH⁻, can be reduced to below −1 V (vs. NHE) at high pH values.

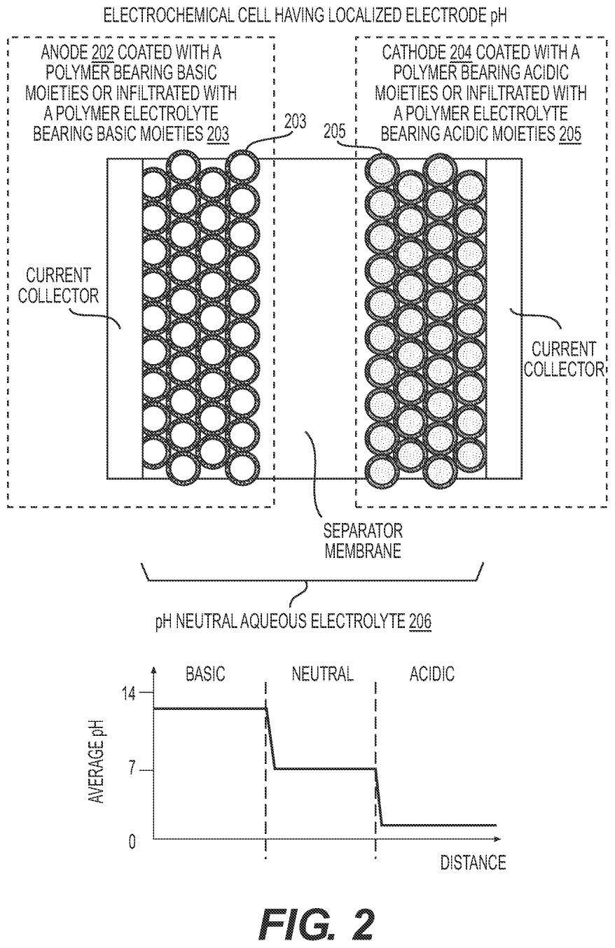

FIG. 2 illustrates an electrochemical cell design for localizing pH at the electrodes to enhance the aqueous electrolyte stability voltage range. In this design, both electrodes, including an anode 202 and a cathode 204, are infiltrated with polymer electrolytes containing pH-tuning moieties 203, 205 of macromolecules without changing the pH in the bulk of a pH-neutral aqueous Li-ion electrolyte solution 206. Because the cathode and anode require shifting of the pH values in the opposite directions in order to prevent water decomposition, the battery electrodes may be separated by a semi-penetrable membrane dividing pH shifting components one from another. This membrane prevents interaction between acidic and basic compounds providing the necessary pH level in each electrode space. At the same time, the membrane should be penetrable for the Li ions and counter ions of the electrolyte salt. An example semi-penetrable membrane can be made from regenerated cellulose (RC). In this way, the pH modifying polymer electrolytes affect the pH value on each electrode only, without changing the pH in the bulk of the battery electrolyte solution (as is further illustrated in corresponding average pH distribution shown in FIG. 2).

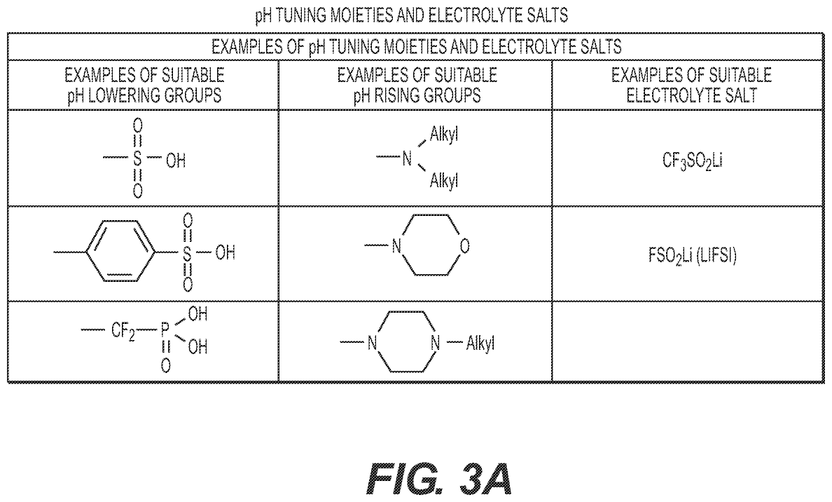

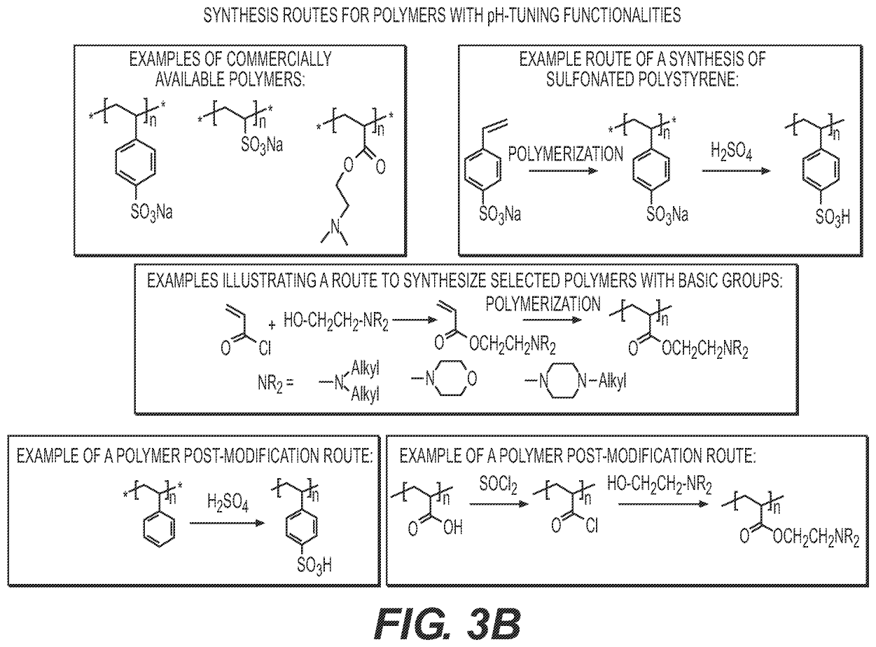

FIG. 3A provides examples of various pH shifting and chemical bonding groups in polymers and polymer electrolyte(s) that may be used in conjunction with the cell design of FIG. 2 and certain usable electrolytes. Decrease of pH in the cathode space can be achieved by dissolving in electrolyte polymer bearing acidic groups and confining it in a cathode space. Acidic groups in the polymer structure include, mentioning a few, carboxylic, phosphoric or sulfuric moieties attached to the main polymer backbone. Depending on the pKa of the acidic group in the polymer, the local pH value can be tuned in wide ranges from pH=6 to pH=0. Among the above-mentioned acids, sulfuric acid is the strongest (with a pKa of approximately −3) thus providing the highest pH shift. To shift the pH value near the anode into basic conditions, polymers bearing amine moieties in their structure can be used. Depending on the pKa of the amine present in the polymer structure, pH values can be varied from pH=7 to pH=12. The polymeric nature of the pH-modifying additives will confine their presence near the desired electrode space. Because an RC membrane, for example, is non-penetrable for polymeric molecules, different pH values can be achieved for both the cathode and anode.

There is a principal requirement for the relative strength of acidic groups present in the polymer electrolyte structure infiltrated into the cathode and acid corresponding to the counter-ion of the Li electrolyte salt. In order to prevent formation of the Li salt on the acidic polymer, the acid corresponding to the salt counter-ion should be stronger then the acidic groups in the polymer structure. This can be achieved if the Li electrolyte salt has a counter ion corresponding to super-acids (which may be referred to herein as a “salt of a superacid”). Some examples of possible electrolytes salts utilizing Li salts of superacids are presented in FIG. 3A. Other examples of super-acid-derived Li salts include, but are not limited to LiCF₃SO₃, LiSO₃F, LiFO₃A, Li₂F[SbF₆], LiN(CF₃SO₂)₂, LiC(CF₃SO₂)₃, LiC₂F₅SO₃, and LiN(C₂F₅SO₂)₂.

A similar requirement exists with regard to the strength of basic groups in the polymer electrolyte structure infiltrated in the anode, which should be weaker bases when compared to LiOH.

The decrease of pH in the vicinity of the electrode can also be achieved by attaching polymer-bearing acidic groups. Long-term stability of the pH-modifying coatings may be enhanced by chemical bonding to the particle surface and/or coating cross-linking (e.g., via the chemical bonding groups shown in FIG. 3A). To obtain a pH modifying polymer capable of chemically bonding to the electrode surface, two monomers may be co-polymerized. One co-monomer may bear a pH-modifying group. The second co-monomer may contain in its structure a chemical group capable of forming covalent bonds with particles of active materials. By changing the ratio between the two co-monomers, the bonding and pH tuning properties of the polymer coating can be tuned for more optimized electrode performance.

FIG. 3B shows examples of synthesis routes for polymers with pH-tuning functionalities. Polymers with acidic (base) moieties can be synthesized, for example, from corresponding vinyl monomers bearing desired functional groups. Some of these monomers are commercially available—for example, styrenesulfonate sodium salt. A corresponding polymer can be prepared by conventional radical polymerization, with subsequent conversion into acidic form by treatment with sulfuric acid. Other examples of commercially available polymers include, for example, sodium salt of poly(vinylsulfonic acid).

Polymers containing amino groups in their structures can be made by radical polymerization of corresponding acrylates (methacrylates) with amino groups in their structure. Acrylate (methacrylate) amino derivatives can be synthesized by coupling of acroyloyl (methacryloyl) chloride and 2-aminoethanol derivatives.

An alternative way to make functional polymers is post modification of the corresponding monomers. Thus polystyrene sulfonic acid can be made by polystyrene sulfonation and aminoacrylates can be synthesized from acrylic acid and 2-aminoethenol derivatives.

In some cases, polymer electrolytes either having or not having specific pH tuning moieties my simply enhance over-potential for water decomposition in pH neutral aqueous electrolytes. Formation of polymer coatings permeable to active electrolyte ions either prior to or after cell assembly may be particular effective for suppressing H₂ evolution on the anode. Examples of suitable methods for polymer coating deposition include chemical vapor deposition (CVD), electrodeposition and electroless deposition before the cell assembling or electrodeposition (e.g., by reducing some of the organic electrolyte additives) in-situ, after the cell assembling. In some examples, the coating may not be a pure polymer, but rather oligomer-comprising and metal-ion salt(s)-, oxide(s)- or fluoride(s)-comprising composite.

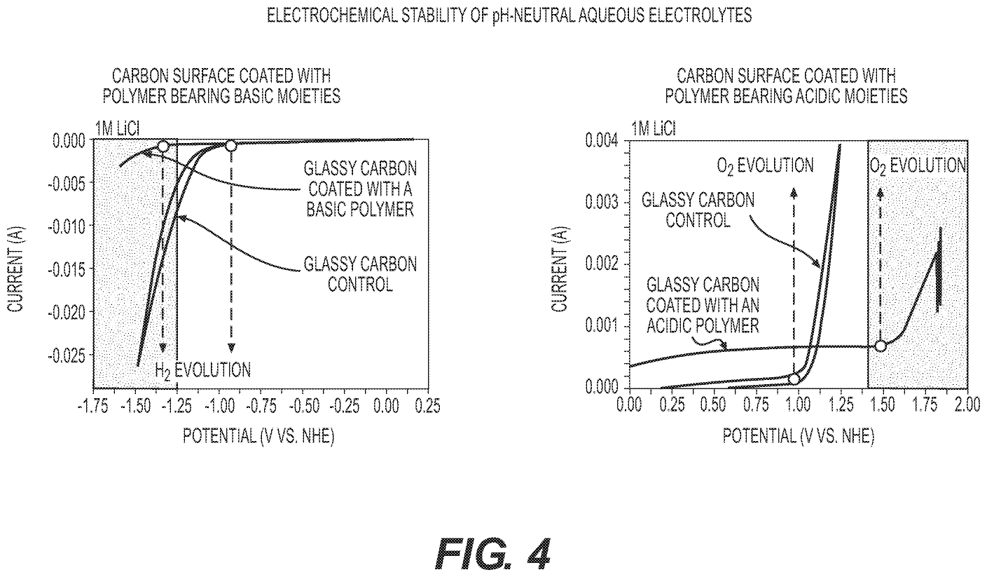

FIG. 4 provides two graphs illustrating the impact of polymer coatings on the surface of glassy carbon working electrodes, on the electrochemical stability of a pH-neutral aqueous electrolyte measured in a 3-electrode configuration. On the left, it can be seen that the voltage stability range is expanded to below −1.2 V vs. NHE by coating a carbon surface with a protective polymer (in this case, bearing basic moieties). On the right, it can be seen that the voltage stability range is expanded to over 1.5 V vs. NHE by coating a carbon surface with a protective polymer (in this case, bearing acidic functional moieties). The higher current observed for the carbon surface with a polymer bearing acidic functional moieties is likely related to the pseudo-capacitance induced by the acidic functional groups of the polymer coating.

It will be appreciated that pH-modifying polymer electrolyte may be in direct contact with the surface of active particles or contact the surface of another layer that coats the active particles, and that this may additionally serve various functions, such as, for example, additionally prevent water decomposition on the electrode surface, prevent degradation of active material, improve electrical conductivity within the electrode, or improve the interface between the active particles and the pH-modifying polymer electrolytes, to name a few.

In some cases, the use of Li electrolyte salt(s), which has a counter ion corresponding to super acids, provides enhanced stability of aqueous Li-ion cells against water decomposition and self-discharge even when pH-modifying surface coatings are not used. The origin of such a performance enhancement is not fully understood, but may be related to the formation of the favorable (protective) surface coatings on at least one electrode during cell operation upon the decomposition of such salt(s) or upon the decomposition of other species present within the aqueous Li-ion cell, catalyzed by the presence of such salt(s).

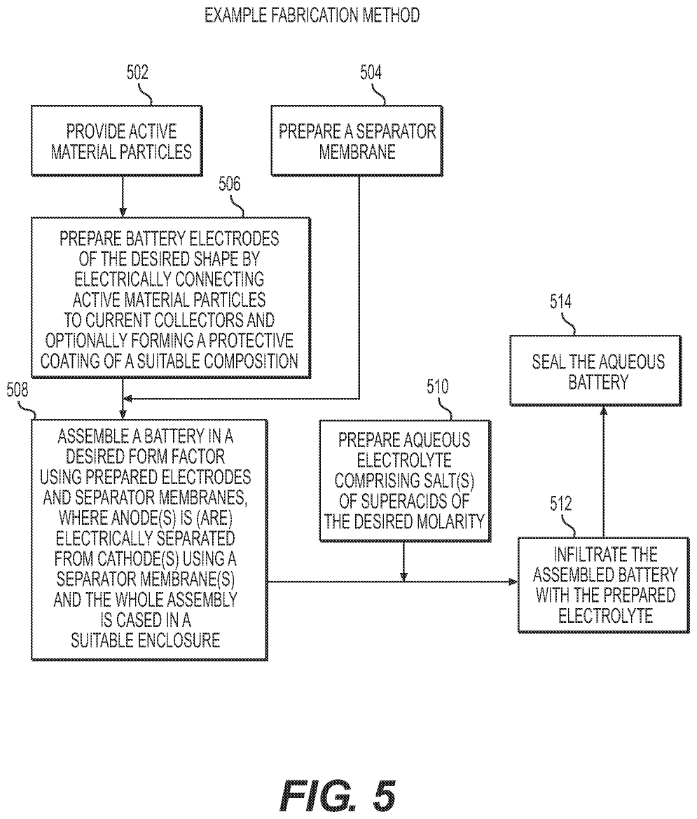

FIG. 5 illustrates a method of aqueous battery fabrication, where the electrolyte comprises salts of superacids. Examples of suitable super-acid-derived Li salts include, but are not limited to LiCF₃SO₃, LiSO₃F, LiFO₃S, Li₂F[SbF₆], LiN(CF₃SO₂)₂, LiC(CF₃SO₂)₃, LiC₂F₅SO₃, and LiN(C₂F₅SO₂)₂.

In the illustrated example of FIG. 5, active material particles are provided (block 502) and a separator membrane is prepared (block 504). Battery electrodes are prepared of the desired shape by electrically connecting active material particles to current collectors and optionally forming a protective coating of a suitable composition (block 506). A battery is then assembled in a desired form factor using the prepared electrodes and separator membranes, where one or more anodes is/are electrically separated from one or more cathodes using a separator membrane(s) and the whole assembly is cased in a suitable enclosure (block 508). An aqueous electrolyte comprising salt(s) of superacids of the desired molarity is also prepared (block 510). The assembled battery is then infiltrated with the prepared electrolyte (block 512), and sealed (block 514).

In addition to Li salts of superacids, other salts of superacids may be utilized as favorable additives for Li-ion aqueous batteries.

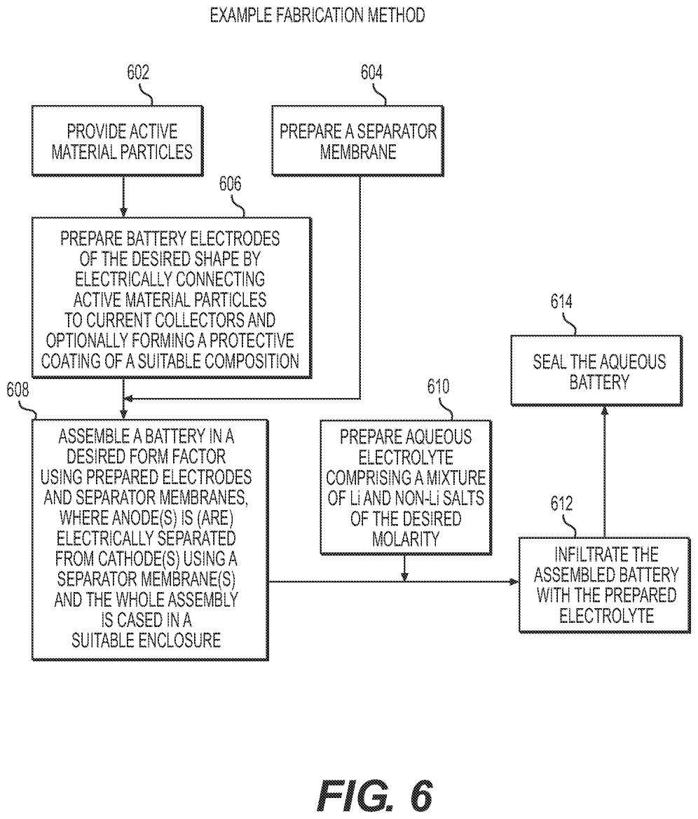

FIG. 6 is a method of aqueous Li-ion battery fabrication, where the electrolyte comprises a mixture of Li and non-Li salts, where either a Li salt or non-Li salt (or both) is a salt of superacids. Examples of suitable non-Li salts of superacids include, but are not limited to the salts of K, Na, Ti, Ta, Tl, Nb, Mg, Sn, Pb, Cd, Zn, Sn, Sb, La, Cr, or Bi. In some cases this mixture of Li and non-Li salts in the electrolyte of aqueous Li-ion cells may offer favorable performance in terms of cell stability, operational temperature window, and, in some case, even rate performance. In one example, this may be a pH-neutral electrolyte comprising 0.9M LiSO₃F and 0.05 M Sn(CF₃SO₃)₂. In another example, this may be a pH-neutral electrolyte comprising 4M LiN(C₂F5 SO₂)₂ and 0.08 M Sn(N(CF₃SO₂)₂)₂. The suitable molar ratios for the mixtures of salts of superacids and salts of other acids may range from 99999:1 to 1:99999, depending on the particular cell chemistry and performance requirements. Since salts of superacids may be expensive, an economic factor (the cost-benefit analysis) may also be considered when selecting the salt mixture for an aqueous pH-neutral Li-ion electrolyte. In one example, this may be a pH-neutral electrolyte comprising 1.5M LiSO₄ and 0.1M Sn(CF₃SO₃)₂. In another example, this may be a pH-neutral electrolyte comprising 4M LiN(C₂F₅SO₂)₂ and 0.01M ZnSO₄.

Furthermore, in some causes an aqueous solution of a mixture of regular Li and non-Li salts (not only the mixture comprising the salts of superacids) may still offer improved performance compared to the use of only Li salt(s). The suitable molar ratios for the mixtures of Li and non-Li salts may range from 99999:1 to 1:20, depending on the particular cell chemistry and performance requirements. In one example, this may be a pH-neutral electrolyte comprising 2M Li₂SO₄ and 0.06M Sb(SO₄)₂.

Furthermore, in some cases a mixture of two or more different Li salts in pH-neutral electrolyte may still offer improved performance compared to the use of only one type of Li salt. The suitable molar ratios for the mixtures of two Li salts may range from 1000:1 to 1:1000, depending on the particular cell chemistry and performance requirements.

In the illustrated example of FIG. 6, active material particles are provided (block 602) and a separator membrane is prepared (block 604). Battery electrodes are prepared of the desired shape by electrically connecting active material particles to current collectors and optionally forming a protective coating of a suitable composition (block 606). A battery is then assembled in a desired form factor using the prepared electrodes and separator membranes, where one or more anodes is/are electrically separated from one or more cathodes using a separator membrane(s) and the whole assembly is cased in a suitable enclosure (block 608). An aqueous electrolyte comprising a mixture of Li and non-Li salts of the desired molarity is also prepared (block 610). The assembled battery is then infiltrated with the prepared electrolyte (block 612), and sealed (block 614).

In some cases, the use of high concentration (such as from above 2M to near-saturation within the temperature window of cell operation) of various salt(s) and their mixtures present in the electrolyte may provide the best performance for aqueous Li-ion cells in terms of enhanced cell stability, minimized self-discharge, or the broadest operational temperature window. This concentrated electrolyte may comprise a single salt or a mixture of salts. In one example, this may be a pH-neutral electrolyte comprising 2.5M Li₂SO₄. In some examples, a favorable electrolyte composition may include high (e.g., 2M or more up to the level when there are more salt molecules than water molecules) concentration of the suitable Li salt(s) of superacids, high concentration of the other suitable Li salt(s), high concentration of Li salts mixed with other suitable salts present in electrolyte, or high concentration of the Li salt mixtures (e.g., Li salts of superacids and Li salts of other acids) present in the electrolyte. The origin of such performance enhancement is also not fully understood, but may be related to the formation of the favorable (protective) surface coatings on the electrodes during cell operation upon the decomposition of such salt(s) or upon the decomposition of other species present within the aqueous Li-ion cell. The suitable molar ratios for the mixtures of two different Li salts (e.g., two different Li salts of superacids, a mixture of Li salt of a superacid and a regular salt, or a mixture of two different salts of “regular” acids, such as for example LiNO₃ and Li₂SO₄ and other suitable mixtures of salts) may range from 99:1 to 1:99, depending on the particular cell chemistry and performance requirements.

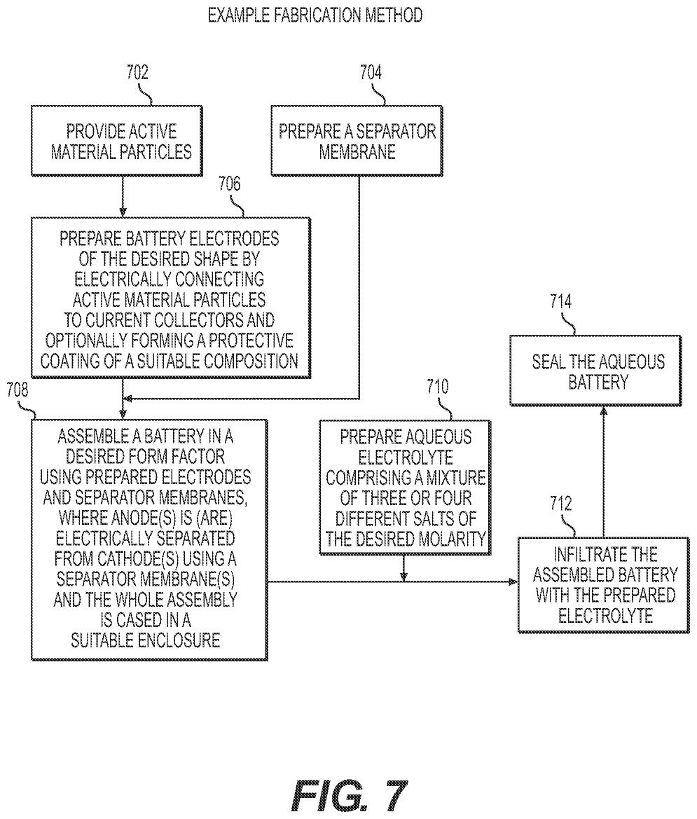

FIG. 7 illustrates a method of aqueous battery fabrication, where the electrolyte comprises a mixture of three or more different salts. Surprisingly, in some applications the most favorable performance may be achieved when ternary or quaternary mixtures of salts are utilized (such as a mixture of three to four different Li salts or a mixture of different Li and non-Li salts, to provide few examples). As an example, such a salt mixture electrolyte may comprise a solution of 2.5M Li₂SO₄, 0.1M SnSO₄, 0.1M Li₂SnO₃ and 0.02M ZnSO₄ in water. Smaller (but still statistically significant) improvements in performance may be achieved when a mixture of 5 or more salts are used in electrolytes.

In the illustrated example of FIG. 7, active material particles are provided (block 702) and a separator membrane is prepared (block 704). Battery electrodes are prepared of the desired shape by electrically connecting active material particles to current collectors and optionally forming a protective coating of a suitable composition (block 706). A battery is then assembled in a desired form factor using the prepared electrodes and separator membranes, where one or more anodes is/are electrically separated from one or more cathodes using a separator membrane(s) and the whole assembly is cased in a suitable enclosure (block 708). An aqueous electrolyte comprising a mixture of three or four different salts of the desired molarity is also prepared (block 710). The assembled battery is then infiltrated with the prepared electrolyte (block 712), and sealed (block 714).

In some applications, the best stability and overall most favorable performance may be achieved when both organic and inorganic salts are used in aqueous pH neutral electrolyte.

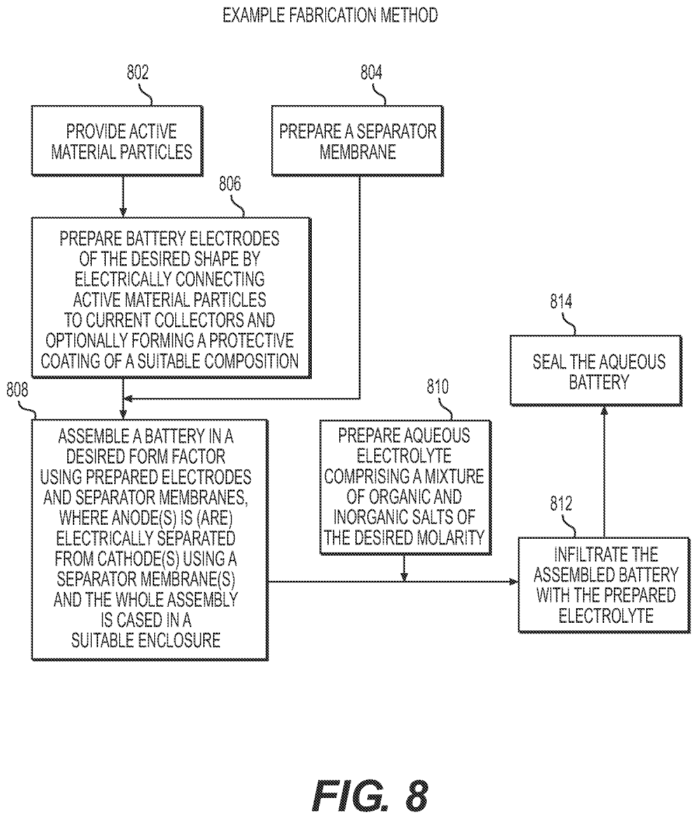

FIG. 8 illustrates an example of a method of aqueous battery fabrication, where the electrolyte comprises a mixture of inorganic and organic salts. The suitable molar ratios for the mixtures of organic to inorganic salts may range from 99999:1 to 1:99999, depending on the particular cell chemistry and performance requirements. Examples of suitable organic or suitable inorganic salt(s) in such an electrolyte composition include, but are not limited to the salts of Li, Na, K, Ti, Ta, Tl, Mg, Sn, Nb, Pb, Cd, Zn, Sn, Sb, La, Cr, or Bi. Examples of suitable organic salts include but are not limited to (listed with respect to Li for brevity) metal salts of carboxylic acids (such as HCOOLi, CH₃COOLi, CH₃CH₂COOLi, CH₃(CH₂)₂COOLi, CH₃(CH₂)₃COOLi, CH₃(CH₂)₄COOLi, CH₃(CH₂)₅COOLi, CH₃(CH₂)₆COOLi, CH₃(CH₂)₇COOLi, CH₃(CH₂)₈COOLi, CH₃(CH₂)₉COOLi, CH₃(CH₂)₁₀COOLi, CH₃(CH₂)₁₁COOLi, CH₃(CH₂)₁₂COOLi, CH₃(CH₂)₁₃COOLi, CH₃(CH₂)₁₄COOLi, CH₃(CH₂)₁₅COOLi, CH₃(CH₂)₁₆COOLi, CH₃(CH₂)₁₇COOLi, CH₃(CH₂)₁₈COOLi and others with the formula CH₃(CH₂)ₓCOOLi, where x ranges up to 50); metal salts of sulfonic acids (e.g., RS(═O)₂—OH, where R is a metal salt of an organic radical, such as a CH₃SO₃Li, CH₃CH₂SO₃Li, C₆H₅SO₃Li, CH₃C₆H₄SO₃Li, CF₃SO₃Li, [CH₂CH(C₆H₄)SO₃Li]n and others) and various other organometalic reagents (such as various organilithium reagents).

In the illustrated example of FIG. 8, active material particles are provided (block 802) and a separator membrane is prepared (block 804). Battery electrodes are prepared of the desired shape by electrically connecting active material particles to current collectors and optionally forming a protective coating of a suitable composition (block 806). A battery is then assembled in a desired form factor using the prepared electrodes and separator membranes, where one or more anodes is/are electrically separated from one or more cathodes using a separator membrane(s) and the whole assembly is cased in a suitable enclosure (block 808). An aqueous electrolyte comprising a mixture of organic and inorganic salts of the desired molarity is also prepared (block 810). The assembled battery is then infiltrated with the prepared electrolyte (block 812), and sealed (block 814).

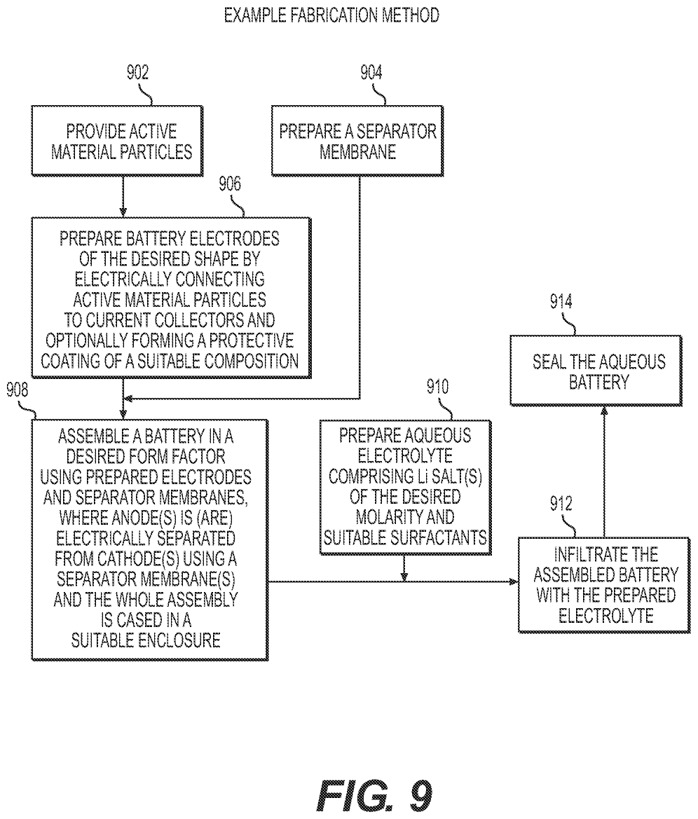

FIG. 9 illustrates a method of aqueous battery fabrication, where the electrolyte comprises a surfactant. The additions of various surfactants as additives to pH-neutral aqueous electrolytes in the concentration from 0.0000001M to 1M may be advantageous in some applications of aqueous Li-ion batteries in terms of improving stability, rate performance, and even capacity utilization. Examples of suitable surfactants include, but not limited to the following types of surfactants having a general formula XSO₃, XSO₄, X(PO₄)_{z}, X(SbF₆)_{z}, X(BF₄)_{z}, X(BO₃)_{z}, X(CrO₄)_{z}, X(NO₃)_{z}, X(CF₃SO₃)_{z}; X(SO₃F)_{z}, X(FO₃S)_{z}, X(F[SbF₆])_{z}, X(N(CF₃SO₂)₂)_{z}, X(C(CF₃SO₂)₃)_{z}, X(C₂F₅SO₃)_{z} and X(N(C₂F₅SO₂)₂)_{z}, where z is between ⅓ and 6 and X is preferably selected from an aryl group, alkyl group, alkylaryl group, carboxy group or their Li, Na, K, Ti, Ta, Tl, Nb, Mg, Sn, Pb, Cd, Zn, Sn, Sb, La, Cr, or Bi salts.

In the illustrated example of FIG. 9, active material particles are provided (block 902) and a separator membrane is prepared (block 904). Battery electrodes are prepared of the desired shape by electrically connecting active material particles to current collectors and optionally forming a protective coating of a suitable composition (block 906). A battery is then assembled in a desired form factor using the prepared electrodes and separator membranes, where one or more anodes is/are electrically separated from one or more cathodes using a separator membrane(s) and the whole assembly is cased in a suitable enclosure (block 908). An aqueous electrolyte comprising Li salt(s) of the desired molarity and suitable surfactants is also prepared (block 910). The assembled battery is then infiltrated with the prepared electrolyte (block 912), and sealed (block 914).

In some applications, the presence of porous metal (or porous carbon) coatings or porous metal (or porous carbon) powder may efficiently prevent H₂ evolution on the anode or O₂ evolution on the cathode. Several metals may offer high over-potentials for H₂ and O₂ evolution, and these have been found to be useful as additives for pH-neutral aqueous Li-ion batteries. For example, iron (Fe) increases the potential of O₂ generation at the cathode by about 0.75 V, nickel (Ni) by 0.56 V, lead (Pb) by 0.81 V, and graphite by 0.95 V. Other metals, for example, Ti, Ta, Tl, Nb, Hg, Mg, Sn, Ph, Cd, Zn, Sn, Sb, La, Cr, or Bi, may also significantly increase the potential of water decomposition at the anode or the cathode, or both, and have been found to be advantageous for use in pH-neutral aqueous electrolytes. All of these materials may be used as coatings, as a powder in electrode construction, or (in some cases, when some dissolution to electrolyte may take place) in metal current collectors. The following is a comprehensive although not exhaustive list of suitable metals, the presence of which in the anode improves cell stability and decreases H₂ generation at the anode at low anode potentials: Ti, Ta, Tl, Nb, Hg, Mg, Sn, Pb, Cd, Zn, Sn, Sb, La, Cr, Bi, or In. If these metals are present in at least one of the electrode (preferably in the anode), then the potential of aqueous electrolyte decomposition on the anode may be lowered by 0.6 V or more.

In addition to using porous metal species in pH-neutral aqueous batteries, the above-discussed metals may be advantageously used as conformal dense coatings, as a powder (e.g., either randomly shaped or as (nano) wires, (nano)fibers, or flakes in the electrode) construction, or in a current collector construction.

However, in some configurations, the presence of micropores and mesopores within such materials may be used to surprisingly prevent water decomposition. It may be the case that hydrogen (for the anode) or oxygen (for the cathode) adsorption in the nanopores prevent nucleation of gaseous species (such as H₂ or O₂) and thus prevent water decomposition.

Currently, aqueous Li-ion batteries are not generally available on the market. However, regular Li-ion batteries utilize thin metal foils as current collectors—most commonly, Cu foil as the anode current collector and Al foil as the cathode current collector. The use of non-planar current collectors may be advantageous for improving rate performance of aqueous Li-ion batteries. Furthermore, Cu and Al current collectors typically suffer from corrosion in aqueous media and cannot normally be used. Metals, such as Ni or Fe, or Ni- or Fe-based alloys, are most commonly used as a metal current collector(s) in other types of aqueous batteries, such as alkaline batteries or nickel metal hydride batteries. Such metals, however, often offer inferior performance when used in aqueous Li-ion batteries. For example, they may accelerate decomposition of electrolytes or induce other undesirable reactions.

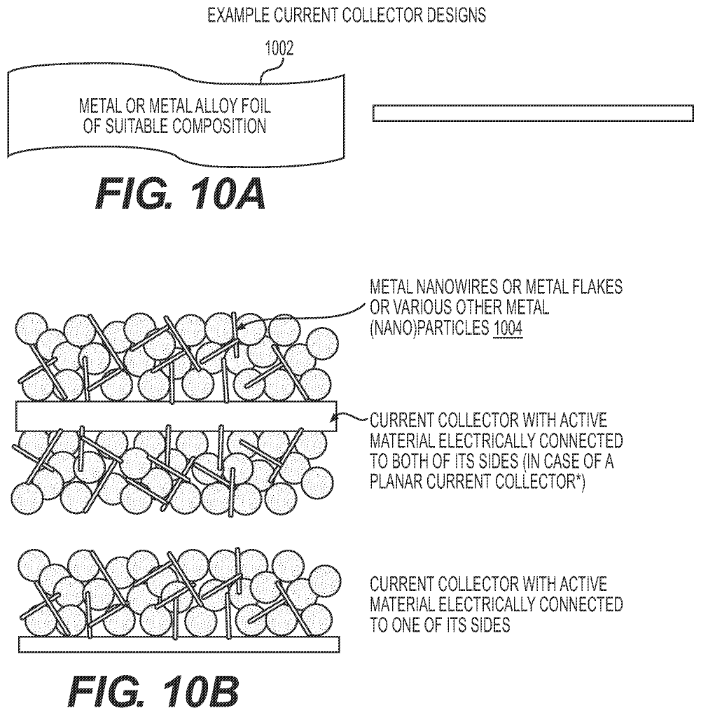

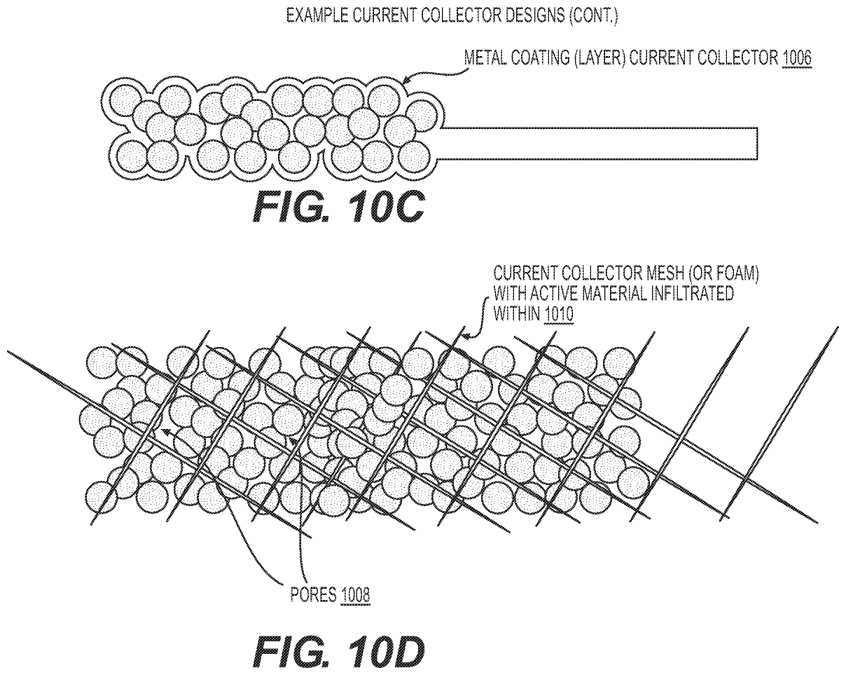

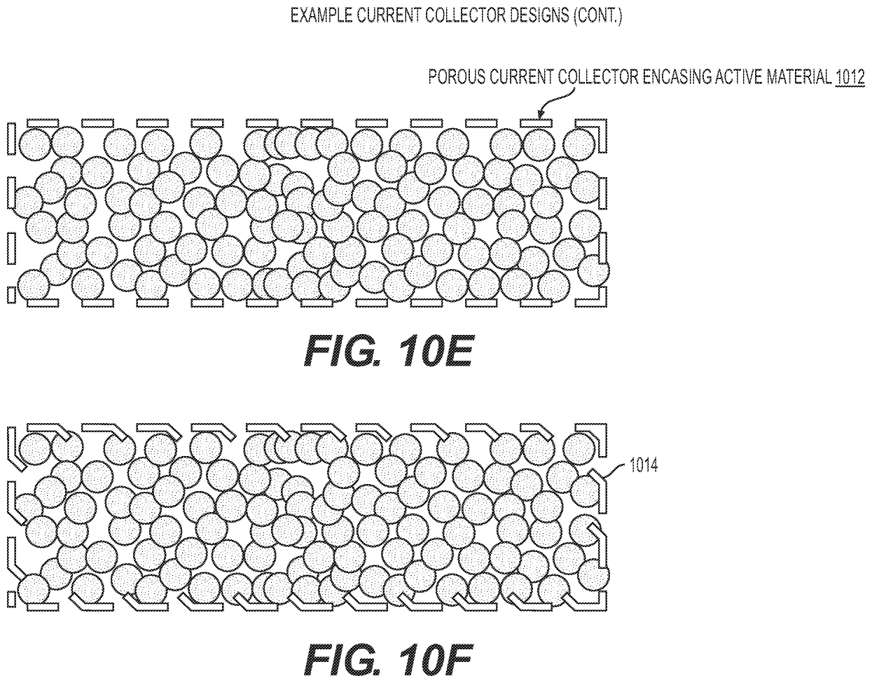

FIGS. 10A-10F illustrate a few examples of improved current collectors and electrodes comprising such current collectors. Although these designs may not ordinarily provide particular benefits to commercial Li-ion batteries with organic electrolytes, they have been found to improve rate performance and stability of aqueous Li-ion batteries, particularly if thick (e.g., 0.25 mm or larger) electrodes are used in their constructions. Metal current collectors should ideally comprise metals or metal alloys that induce overpotential for H₂ generation at the anode by more than 0.3 V and induce overpotential for O₂ generation at the cathode by more than 0.3 V in pH neutral aqueous solutions. In one example, the electrodes are attached to a metal foil current collector 1002 and additionally comprise metal (nano)wires or metal flakes 1004, which also serve to collect electrical current. In another example, the active particles of the electrode are electrically interconnected and additionally coated with a thin (e.g., 2-5000 nm) metal layer 1006. Such a metal layer (at least partially coating at least 1% of the active material particles or electrically connected agglomerates of such particles) serves as a current collector. This metal layer may be deposited by CVD, by electroless deposition, by electrodeposition, or by other suitable methods of conformal metal coating deposition. This electrode of metal-coated particles may be additionally electrically connected to a secondary metal current collector (which may be in the form of a foil, a sheet, a rod, or a cylinder). To achieve rapid ion transport, the electrode may additionally comprise interconnected pores 1008 to be filled with electrolyte when used in an aqueous Li-ion battery. In another example, the electrode may comprise active particles (with an optional binder) that are infiltrated into a metal current collector mesh or metal current collector grid 1010, or other types of porous metal current collector. An additional coating of a thin (e.g., 2-5000 nm) metal layer may be optionally be applied and similarly serve as a current collector. The electrode may also optionally comprise metal (nano)wires or metal flakes, which also serve to collect electrical current. In yet another example, the electrode may comprise active particles (with an optional binder) that are infiltrated into porous metal current collector tubes 1012 or sandwiched between two porous metal current collector sheets or foils (optionally connected at the sides and thus creating a cavity in between). In one configuration, the holes (pores) in the metal current collector may be punched after the interior of the current collector (cavity of the current collector tubes or two interconnected foils/sheets) is already filled with active electrode material. Furthermore, holes may be punched only partially so that the parts of the current collector material 1014 is pushed into the electrode to strengthen the electrode construction and improve its electrical connectivity.

The current collectors for anodes may preferably comprise metals or metal alloys comprising 1-99.999% of at least one of the following elements (or materials): lead, zinc, mercury, cadmium, copper, tin, antimony, gallium, titanium, thallium, tantalum, niobium, molybdenum, indium, or bismuth. In some cases, the use of two or more elements from the above list may be particularly advantageous. Alternatively, conventional aqueous battery current collectors (e.g., Ni or Fe) may be coated with a conductive layer comprising 1-99.999% of the following elements: lead, zinc, mercury, cadmium, copper, tin, antimony, gallium, titanium, thallium, tantalum, niobium, molybdenum, indium, or bismuth. In some applications, various conductive carbons (such as graphite, graphite flakes, graphene, carbon fibers, carbon nanofibers, carbon nanotubes, carbon black, and others) may also be used in the construction of anode current collectors. CVD, spraying, sputtering, electroless deposition and electrodeposition have been found to work well for the formation of such coating layers. In some configurations, such a layer may be a polymer-metal (with metal and metal alloying comprising lead, zinc, mercury, cadmium, copper, tin, antimony, gallium, titanium, thallium, tantalum, niobium, molybdenum, indium, or bismuth) composite coating (e.g., a composite paint). Such a composite may be deposited using a variety of methods, including spraying, doctor-blade coating, and other known methods for paint deposition. Carbon black, carbon fiber(s), carbon nanofibers, carbon nanotubes, graphene, graphite flakes, exfoliated graphite, graphite, templated carbon, porous carbon, and other types of conductive carbons and their mixtures may be used instead of (or in addition to) metals in the polymer composite configuration.

The current collectors for cathodes may preferably comprise metals or metal alloys comprising 1-99.999% of at least one of the following elements (or materials): lead, cadmium, copper, nickel, antimony, gallium, titanium, thallium, and tantalum. Gold and platinum have been found to work particularly well, but they are typically too expensive for most applications. In some cases, the use of two or more elements from the above list may be even more advantageous. Alternatively, conventional aqueous battery current collectors (e.g., regular Ni) may be coated with a conductive layer comprising 1-99.999% of the following elements: lead, cadmium, copper, nickel, antimony, gallium, titanium, thallium, and tantalum. In some applications, various conductive carbons (such as graphite, graphite flakes, graphene, carbon fibers, carbon nanofibers, carbon nanotubes, carbon black, and others) may also be used in the construction of the cathode current collectors. At very high voltages (e.g., above around 1.2-1.5 V vs. NHE), however, carbon could be oxidized, which is undesirable. Therefore, utilizing thermally stable graphitic carbons (e.g., carbons that were annealed at temperatures of 1200-2200° C. in an inert environment) may be advantageous.

CVD, spraying, sputtering, electroless deposition and electrodeposition have been found to work well for the formation of such coating layers. In some configurations, such a layer may be a polymer-metal (with metal and metal alloying comprising lead, cadmium, copper, nickel, antimony, indium, gallium, titanium, thallium, and tantalum) composite coating (e.g., a composite paint). Such a composite may be deposited using a variety of methods, including spraying, doctor-blade coating, and other known methods for paint deposition. Carbon black, carbon fiber(s), carbon nanofibers, carbon nanotubes, graphene, graphite flakes, exfoliated graphite, graphite, templated carbon, porous carbon and other types of conductive carbons and their mixtures may be used instead of (or in addition) to metals in the polymer composite configuration. Utilizing more thermally stable graphitic carbons (e.g., carbons that were annealed at temperatures of 1200-2200° C. in an inert environment) may be advantageous for using with high voltage cathodes (e.g., cathodes operating at above 1.2 V vs. NHE).

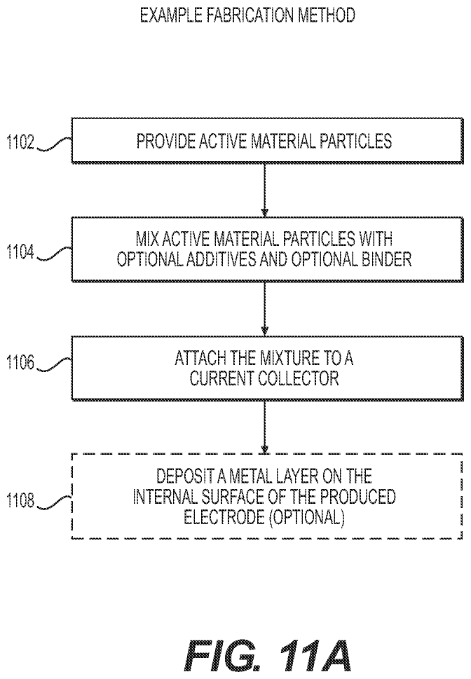

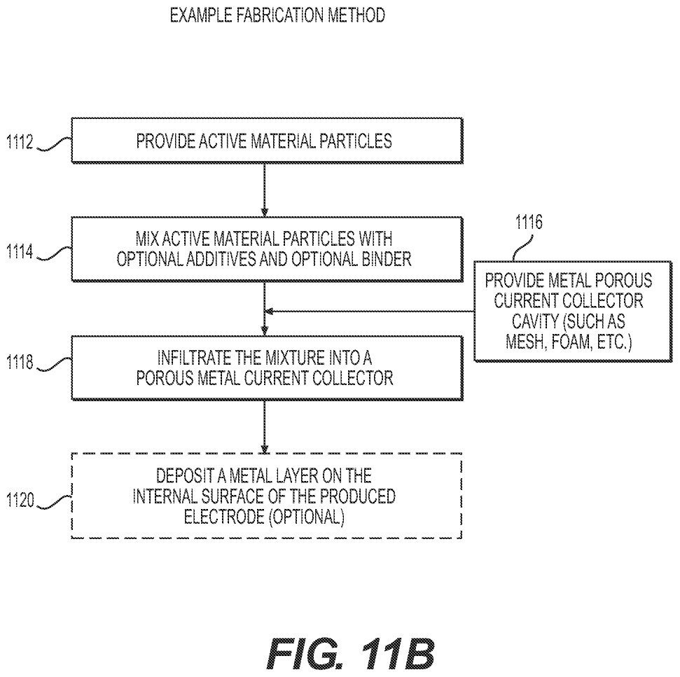

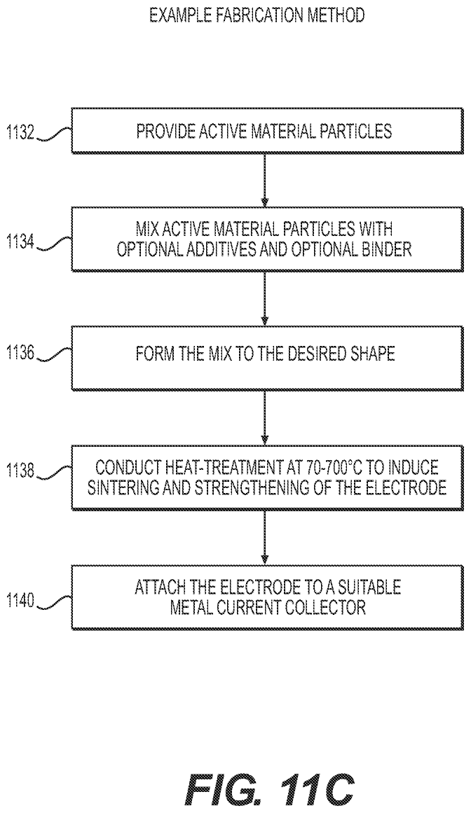

FIGS. 11A-11C illustrates a few examples of suitable methods for fabricating electrodes for aqueous Li-ion batteries. According to one example method, the active powder with optional additives and optional binder is mixed and firmly attached to a metal current collector (e.g., in the form of a cod, a foil, a cylinder, a mesh, or a foam). The produced electrode is additionally optionally coated with a metal layer, which may serve to reduce (or eliminate) electrolyte decomposition, to conduct electrical current, or to serve other suitable functions. In another example method, the active powder with optional additives and optional binder is mixed together and infiltrated into a current collector cavity or current collector foam or mesh. The current collector cavity may already contain holes (pores) or such pores may be produced after the cavity is infiltrated with active material. In yet another example method, the active powder with optional additives and optional binder is first mixed together, then formed into a desired shape (e.g., a cylinder, a rod, or a sheet), then heated to a temperature of 60-700° C. (depending on the active material composition) to induce sintering and strengthen the electrode. It may be important though not to induce undesirable phase transformations during this sintering process, not to close desirable pores within the electrode, not to induce undesirable oxidation, and not to induce excessive growth of active particles. Metal current collectors may be attached to the electrode before or after sintering (depending on the properties of the metal and compatibility of the metal and electrode material at sintering temperatures). Also, a suitable metal coating may be deposited before or after sintering.

In the illustrated example of FIG. 11A, active material particles are provided (block 1102) and mixed with optional additives and an optional binder (block 1104). The mixture is then attached to a current collector (block 1106) and, if desired, a metal layer may be deposited on the internal surface of the produced electrode (optional block 1108).

In the illustrated example of FIG. 11B, active material particles are provided (block 1112) and mixed with optional additives and an optional binder (block 1114). A metal porous current collector cavity (such as a mesh, foam, etc.) is also provided (block 1116). The mixture is then infiltrated into a porous metal current collector (block 1118) and, if desired, a metal layer may be deposited on the internal surface of the produced electrode (optional block 1120).

In the illustrated example of FIG. 11C, active material particles are provided (block 1132) and mixed with optional additives and an optional binder (block 1134). The mixture is then formed to the desired shape (block 1136) and a heat-treatment is conducted at 70-700° C. to induce sintering and strengthening of the electrode (block 1138). The electrode is then attached to a suitable metal current collector (block 1140).

In some applications, the presence of the following salts or oxides in at least one of the electrode(s), an electrolyte, or a separator membrane has been found to be suitable to enhance the voltage stability window and reduce self-discharge and degradation of pH-neutral aqueous Li-ion batteries: oxides comprising tin (Sn), mercury (Hg), cadmium (Cd), zinc (Zn), antimony (Sb), chromium (Cr), bismuth (Bi), thallium (Ta), indium (In), gallium (Ga) or lead (Pb) or salts comprising tin (Sn), mercury (Hg), cadmium (Cd), zinc (Zn), antimony (Sb), chromium (Cr), bismuth (Bi), thallium (Ta), indium (In), gallium (Ga), silicon (Si), or lead (Pb). Examples of such suitable salts include, but are not limited to the acetates, fluorides, sulfates, sulfonates, carbonates, citrates, nitrates, phosphates and antimonides of the above metals. In some applications, the addition of two or more types of these salts or salts comprising more than one of the above elements into the electrolyte may provide complimentary enhancements. For example, the addition of one salt may increase H₂ evolution overpotential on the anode, while the addition of the other salt may enhance the cell rate performance or lead to even stronger increase in the H₂ evolution overpotential. In some configurations, electrolyte additives suitable for the enhancement in anode performance in pH-neutral Li-ion aqueous electrolytes comprise oxygen (O), fluorine (F), sulfur (S), or selenium (Se) elements. When cost is a consideration, the use of salts comprising less expensive elements (such as Zn, Cd, Sn, Sb, Pb, Bi, C and S) may be advantageous.

In some configurations electrolyte decomposition or undesirable interactions between the active material and the electrolyte may be avoided if the electrically connected active particles are coated with a protective layer coating.

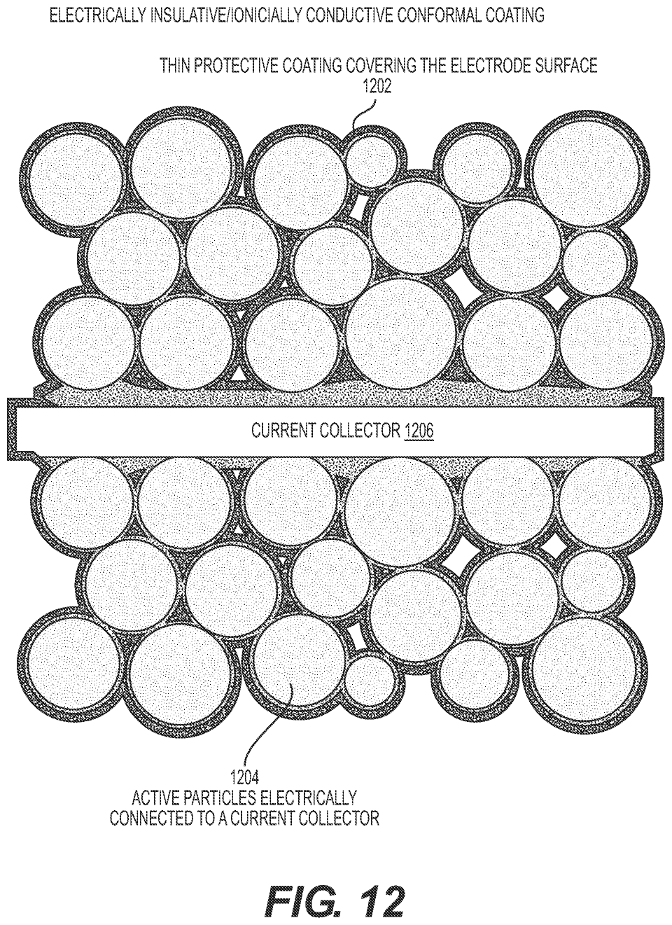

FIG. 12 is a cross-sectional view of an electrode illustrating the use of an electrically insulative but ionicially conductive conformal coating. In this example, a thin protective coating 1202 is provided to cover the electrode surface via active particles 1204 electrically connected to a current collector 1206. In some applications, it may be advantageous to form such a conformal, electrically insulative (i.e., essentially or substantially impermeable to electrons) but ionically conductive (i.e., essentially or substantially permeable to ions participating in energy storage) conformal coatings on the surface of electrodes for aqueous meal-ion batteries or hybrid alkaline/metal-ion batteries.

Conventionally, the voltage between the anode and the cathode of an aqueous cell is applied across an aqueous electrolyte layer. When such a voltage exceeds some critical value (often in the range of about 0.6 V to about 1.9 V), water decomposition takes place with oxygen evolution on the cathode or hydrogen evolution on the anode or both. However, if one or both electrodes are coated with a thin electrically insulative but ionically conductive protective layer, this voltage drops across both the electrolyte and the protective layer in series. This provides a particular advantage for stabilizing an aqueous electrolyte against decomposition.

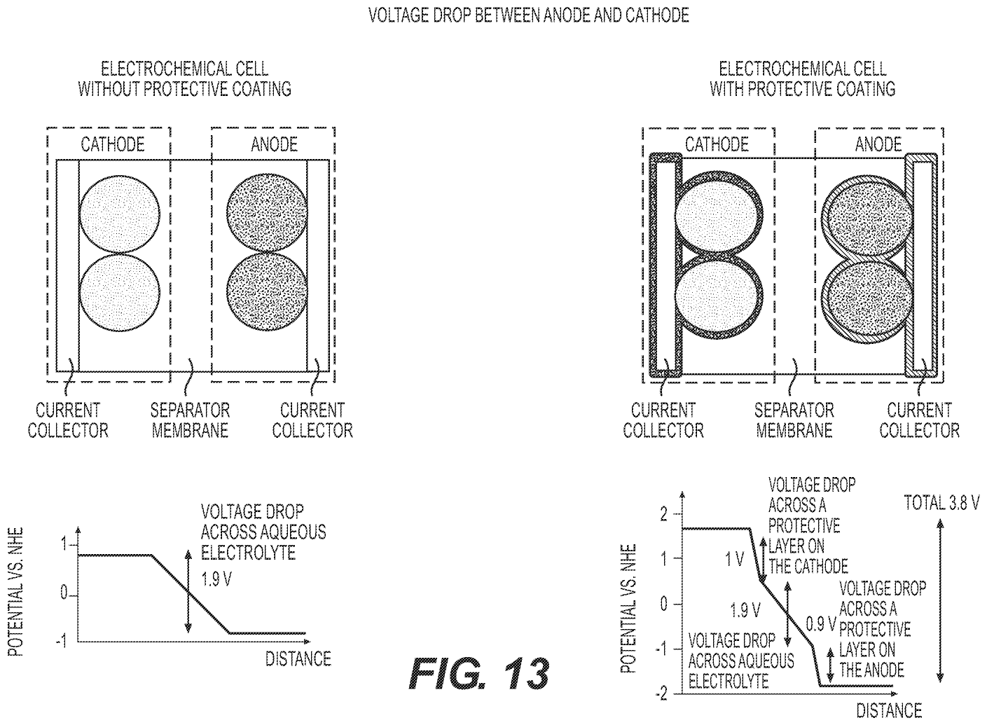

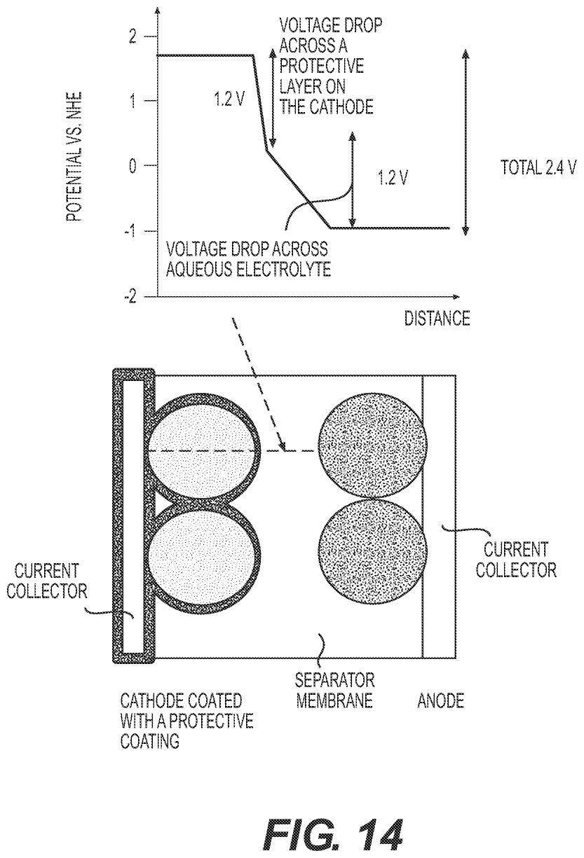

FIGS. 13-14 illustrate the voltage drop between the anode and the cathode of an aqueous cell with (FIG. 13, right, and FIG. 14) and without (FIG. 13, left) a protective coating. As shown, if, for example, the total ionic (e.g., Li ion) resistance of this protective layer(s) approximately equals the ionic resistance of the aqueous electrolyte, the voltage drop across the aqueous electrolyte becomes approximately half of the potential difference between the anode and the cathode. If, for example, by using pH modifying moieties on the surface of the protective layer, the stability range of an aqueous electrolyte can approach 1.9 V, then the maximum voltage between the anode and the cathode may safely approach 3.8 V because half of that voltage will be dropped across the protective layer. In this case, the voltage of such an aqueous Li-ion cell, for example, approaches that of the conventional Li-ion cell with an organic electrolyte. This high voltage increases the energy density of the aqueous Li-ion cell, which can be particularly important for practical applications.

FIG. 14 shows an example where the voltage drop between the anode and the cathode of an aqueous cell with a protective coating only on the cathode and without a protective coating on the anode. The total voltage drop between the electrode is 2.4 V, where 1.2 V is dropped across the protective cathode coating and 1.2 V is dropped across electrolyte.

According to various embodiments, the overall ionic resistance of the protective layer(s) can be adjusted to provide an optimum combination of high total cell voltage, power performance, and reliability. Further, the protective layer may be applied to an anode, a cathode, or both. If applied to an anode, it may prevent hydrogen evolution at low anode potentials. If applied to a cathode, it may prevent oxygen evolution at high cathode potentials.

In many applications, it may be advantageous for this protective layer to uniformly coat the electrolyte-accessible surface of the (porous) electrode. This is because non-uniformities in the layer thickness may induce undesirable variations in the resistivity of the protective layer. If some portion of the protective layer becomes too thin in some area of the electrode, the voltage drop across the aqueous electrolyte may exceed a critical value leading to water decomposition. If some portion of the protective layer becomes too thick in some area of the electrode, it will impede the ion transport in this area, limiting capacity utilization at high current densities. For practical reasons, it may be desirable to have no more than a three-fold variation in the thickness of the protective layer within the protected electrode.

In some applications, it may be advantageous for the overall coating thickness of the protective coating layer to range from about 10 nm to about 500 nm. Thinner coatings may be prone to defects. In some cases, coatings thinner than 5 nm may allow quantum mechanical tunneling of the electrons, which is undesirable as it will permit electrochemical reduction or oxidation of water at extreme potentials and may prevent the protective coating from functioning properly. Coatings thicker than 500 nm may impede ion transport or contribute to a significant portion of the total mass or volume, which may also be undesirable.

The ionic conductivity of the protective layer may be made relatively low. For example, when the effective diffusion distance of Li ions in the aqueous electrolyte is 1.6 mm, its ionic resistance (per 1 cm² area of the electrode) will be equal to (0.16 cm)*(1/0.075 mS cm⁻¹)=2.1 Ohm, assuming ionic conductance of the aqueous Li electrolyte to be 75 mS/cm. By way of example, consider a design in which the porous electrode surface area is 100 times larger than the geometrical area of the electrode (due to internal porosity) and that this surface is uniformly coated with the protective layer. In this example, the thickness of the protective layer is 20 nm and its resistance is set to 2.1 Ohm. Accordingly, the Li ionic conductance of this layer will be a mere (0.000002 cm)/(100)/(2.1 Ohm)≈10⁻⁸ S cm⁻¹. When the effective diffusion distance of Li ions in the aqueous electrolyte is larger (e.g., 8 mm, for example), the Li ionic conductance of this layer must be even smaller, a mere≈10⁻⁹ S cm⁻¹. This is a relatively low value, and straightforward to achieve in many water-compatible ceramic and polymer materials. It does not require development of water-compatible highly conductive solid electrolytes.

The application of such conformal protective coating(s) on the porous electrode surface provides several key advantages over, for example, a thick solid conductive membrane layer that separates the aqueous electrolyte from a solid nonporous electrode or a porous electrode filled with a non-aqueous electrolyte. First, the conformal protective coatings do not require high conductance for providing high overall power performance. Second, in most cases, these coatings are significantly less expensive to deposit because their thicknesses are quite small and because they do not need to possess high ionic conductance. Third, such coatings are more resistant to failure because even if one particle fails (e.g., due to a coating defect) and reacts with the electrolyte, the whole cell can continue to function, losing only a tiny fraction of the overall capacity. Furthermore, as discussed elsewhere herein, the defect may be sealed or repaired during cycling by using additives within the electrolyte. In contrast, the high conductivity thick membranes (typically 10-500 microns) that may, in principle, also be used, suffer from high prices that make them uncompetitive and low conductivity that fail to provide high power performance. More importantly, if a large defect develops within such a membrane, it may ruin the entire cell because the individual particles are not protected.

Formation of the insulative but ionically conductive protective layer conformal coatings on the electrode surface can be performed via electro-reduction (on the anode) or electro-oxidation (on the cathode) of ceramic precursors dissolved in aqueous electrolyte. For example, electro-reduction of the metal ions on the anode can be used to synthesize a variety of metal hydroxide or oxide films. The oxide formation instead of metal (Me) electro-deposition can be achieved by bath composition. For example, metal nitrates will yield hydroxide (oxide) films. Examples include, but are not limited to, ions of Mg²⁺, Al³⁺, Cr³⁺, Fe³⁺, Mn³⁺, and Co²⁺. However, salts of Cu, Tl, Bi, and Pb yield only metal deposits in the case of nitrate counter ions. Utilization of perchlorate salts of Cu, Tl, Bi, or Pb results in hydroxide (oxide) formation during electro-reduction.

Another method for synthesizing oxide films is galvanostatic reduction in the presence of hydrogen peroxide. Coatings consisting of ZrO₂, Al₂O₃, Al₂O₃—ZrO₂, and Al₂O₃—Cr₂O₃ can be made by this approach.

Oxide coatings on the battery electrode can be obtained, for example, by a two-step process. In the first step of this example, a metal coating is made by electroplating. In the second step, the metal coating is converted into oxide by electro-oxidation. Oxides of the metal, which can be electrodeposited from aqueous solutions, can be deposited in this way.

Metal oxide/hydroxide films can be generated by oxidation at the cathode. The pH of the electrolyte is chosen in such a way that the lower oxidation state is stable while the higher oxidation state readily undergoes hydrolysis to yield the metal oxide or hydroxide. Examples include, but are not limited to, MnO₂, PbO₂, V₂O₅, MnO(OH), and CoO(OH).

By fine-tuning the applied cell potentials, the oxidizing or reducing power can be continuously varied and suitably selected. Galvanostatic, potentiostatic, and cyclic voltammetry (CV) modes of deposition or their combinations can be utilized for formation of the coating with desired properties.

Formation of the insulative but ionically conductive protective layer conformal coatings on the electrode surface may also be performed via electro-grafting of monomers present in an electrolyte solution. In this case, it is preferable that electro-grafting takes place at potentials where the majority of electrolyte solvent remains stable. In some applications, it may be preferable for the electro-grafting to take place in-situ during the first cycle of the aqueous metal-ion battery. In this case, a monomer should be dissolved in this electrolyte aqueous solution. In some applications, this electro-grafting may be employed as a secondary safety measure; that is, if the pre-deposited coating fails in some part of the electrode or in some part of an active particle due to a manufacturing defect, this water decomposition site will be neutralized by in-situ formation of the grafted layer.

In one example, a vinyl monomer present in the electrolyte solution may be used as a precursor for electro-grafting. Upon battery charging, a negative potential applied to an anode will cause reduction of the double bond of the vinyl monomer, causing anion formation, which, in turn, will cause monomer polymerization and grafting to the electrically conductive electrode (electron conductive) or electrically conductive site(s) on the electrode surface.

Formation of the insulative but ionically conductive protective layer conformal coatings on the electrode surface may also be performed by CVD and electroless deposition.

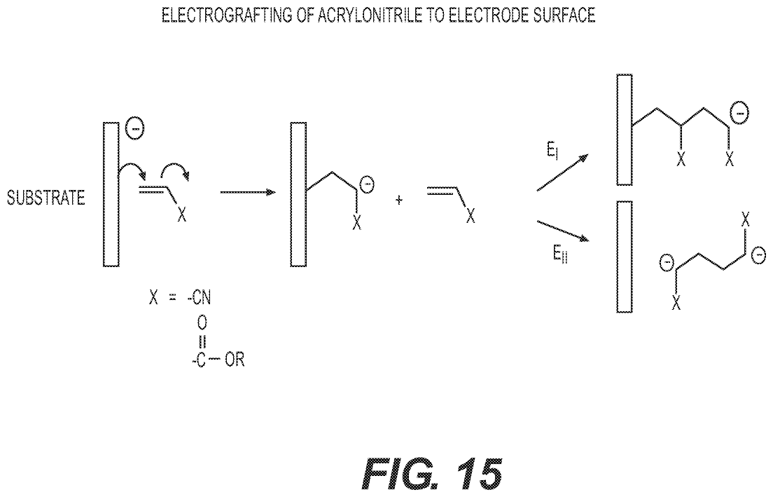

FIGS. 15-17 are schematic illustrations of different examples of in-situ formation of the protective coating layer on an electrode via different suitable precursors.

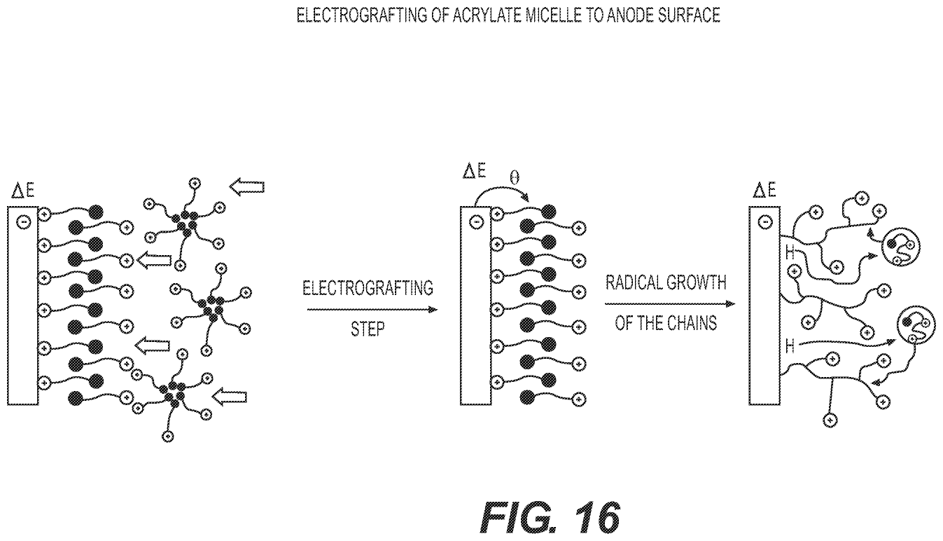

In one example, acrylonitrile may be electro-grafted on the electrode surface, as shown schematically in FIG. 15. Via proper design of the (meth)acrylate monomers, electro-grafting in water media is also an option, as shown schematically in FIG. 16. Three major structural features of the monomer have been found to be advantageous in this regard: (i) a long hydrophobic alkyl chain capable of expelling water from the electrical double layer of the battery electrode and increasing the electrochemical window of the aqueous electrolyte; (ii) the capping of this chain by a cationic hydrophilic head at one end in order to trigger micellization and desorption to the anode surface; and (iii) the capping of the second chain-end by a polymerizable acrylic fragment.

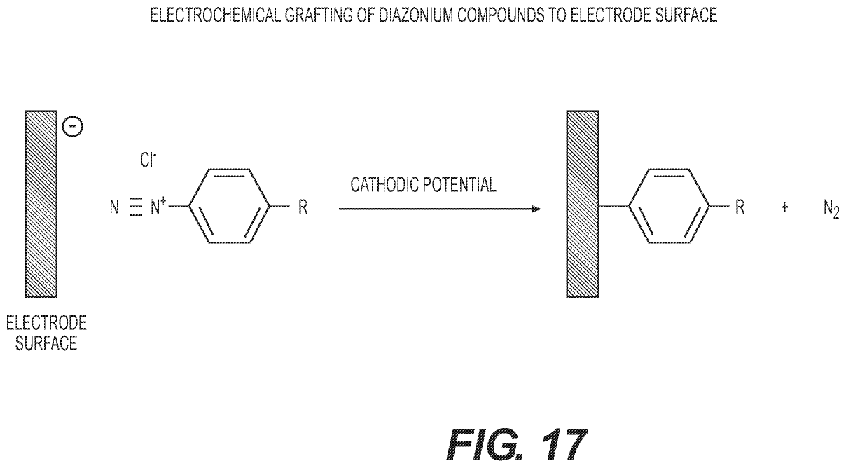

Other examples of a suitable precursor for the in-situ formation of the protective coating layer on an electrode (such as the anode) are diazonium salts' derivatives. These molecules can be cleaved when electro-reduced on the battery anode, as shown schematically in FIG. 17. The radicals formed as a result of an electron transfer from the conductive anode surface (or conductive site on the anode surface) eventually induce formation of a covalent bond with the electrode. Because the electro-grafted molecules are neutral, no polyaddition reaction occurs (in contrast to the electro-reduction of acrylic monomers). The nature of the substituent R in the aromatic ring can be tuned in order to achieve the desired ionic resistance of the coating layer.

Careful selection of the electro-grafting conditions (such as reagent concentration, grafting potential, and, when grafting is performed in a different cell, pH of the grafting solution) allows for a stable surface layer formation with a desired morphology and precise control of film thickness and ionic resistivity.

In some configurations, the aqueous electrolyte may be a basic aqueous solution (e.g., a solution of lithium hydroxide, LiOH). In this case, the half-cell reaction on the anode may involve oxidation of a metal, for example Fe, Zn, Cd, and other suitable metals. In case of Fe, the half cell reaction may be expressed, for example, as: 3Fe_{(solid)}+8OH⁻_{(aqueous)}→Fe₃O_{4(solid)}+4H₂O_{(liquid)}+8e⁻, where e⁻ is an electron. In some configurations (when the aqueous electrolyte is a basic aqueous solution), the half-cell reaction on the cathode may involve Li insertion into a Li storing host material, such as Li intercalation compound (such as lithium metal phosphate or lithium metal silicate or lithium metal oxide, such as lithium-nickel-manganese-cobalt oxide, NMC, or lithium-manganese oxide, LMO, or lithium cobalt oxide, LCO, or lithium nickel cobalt aluminum oxide, NCA, to name a few examples, or another type of Li intercalation material with or without a protective coating layer) or a shell-protected conversion-type material (such as a metal fluoride, to name an example). In the case of an LMO intercalation-type cathode, the half-cell cathode reaction may be written, for example, as: 8e⁻+8Li⁺_{(aqueous)}+16Li_{0.5}Mn₂O_{4(solid)}→16LiMn₂O_{4(solid)}. In some cases, a basic electrolyte solution may induce undesirable damage to the electrode material. In such situations, a Li-ion permeable protective coating (stable in such basic electrolytes) may be comformally deposited on the cathode (or cathode particles), encasing the active cathode material and preventing cell degradation.

In some configurations, when the aqueous electrolyte is a basic aqueous solution, the half-cell reaction on the cathode may involve Li insertion into a Li storing host material, while the half-cell reaction on the anode may involve an oxidation of a metal, so that the full cell discharge process involves movement of Li⁺ cations from aqueous electrolyte into the cathode and movement of OH⁻ anions from aqueous electrolyte into the anode, such as 3Fe_{(solid)}+8LiOH_{(aqueous)}+16Li_{0.5}Mn₂O_{4(solid)}→Fe₃O_{4(solid)}+4H₂O_{(liquid)}+16LiMn₂O_{4(solid)}.

In some configurations, in order to prevent oxygen evolution on the Li-ion hosting cathode, the cathode may also be protected by a conformal coating, that either accommodates some of the voltage drop across the two electrodes (and thus results in aqueous electrolyte “seeing” smaller electrode potential, where it is stable) or increases oxygen evolution over-potential, or performs both of these functions. FIG. 12 illustrates an example where the protective coating on the cathode prevents aqueous alkaline electrolyte decomposition at higher voltages and the associated oxygen evolution.

As previously mentioned, it is particularly important that protective coatings deposited on electrodes are stable in electrolyte solutions. CrO (chromium oxide), NiO (nickel oxide), lanthanides oxides (such as La₂O₃, Nd₂O₃, Sm₂O₃ and others) are examples of suitable protective coatings stable in LiOH alkaline solutions. Such coatings may be applied to the cathodes to prevent oxygen evolution at higher potentials.

Examples of metals stable in LiOH solutions (in certain potential range) include Ni, Cr, and Au, to name a few.

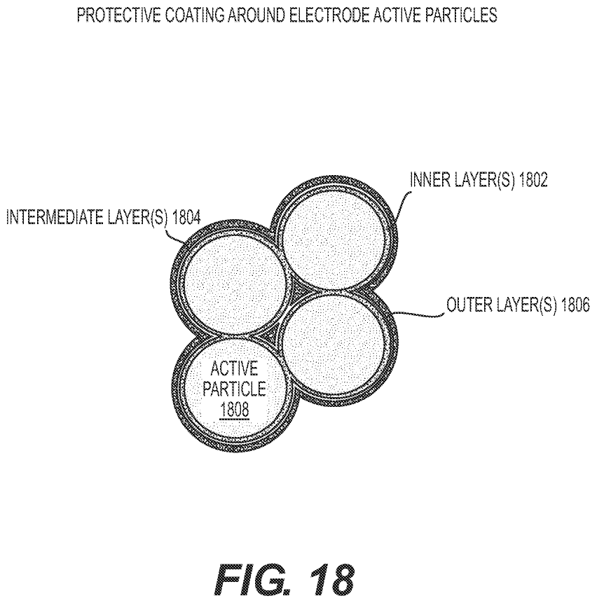

FIG. 18 illustrates an example multi-layer implementation of the protective coating layer impeding aqueous electrolyte decomposition. In this example, the multilayer coating structure includes one or more inner layers 1802, one or more intermediate layers 1804, and one or more outer layers 1806 disposed on or around active particles 1808, although it will be appreciated that the number and arrangement of the different layers may vary from application to application as desired. Each of the layers may bear different functions.

An inner layer may be deposited, for example, to assist in electrically connecting active particles of the electrode. In this case, this layer should be made electrically conductive. Examples of materials for such a layer include but are not limited to a conductive carbon coating or a conductive metal or metal alloy coating, which should be stable in the potential range for the electrode of interest. Examples of such suitable metals include but are not limited to Pb, Cd, Ni, Cu, Fe, Bi, In, Sn, Zn, Ti, Tl, Ta, and alloys comprising at least some fraction (e.g., at least 1%) of at least one of these elements.

An intermediate layer can also be deposited in order to assist in forming a uniform coating of any subsequent layers. Examples of materials for such a layer include but are not limited to metal(s), metal alloy(s), metal oxide(s), metal fluoride(s), metal sulfide(s), various other ceramic coatings, polymer(s), and composite(s), to name a few. It is desirable that this material should also be stable in the potential range for the electrode of interest and not undergo undesirable phase transformation reactions.

Another intermediate layer can also be deposited in order to enhance the mechanical properties of the overall coating or enhance mechanical stability of individual particles. Examples of materials for such a layer include but are not limited to carbon, metal(s), metal alloy(s), metal oxide(s), metal fluoride(s), various other ceramic coating(s), and composite(s), to name a few.

One or more outer layer(s) may be deposited to provide additional protection against aqueous electrolyte decomposition or other useful functions. Examples of materials for such a layer include but are not limited to various metal(s) (as previously described), metal oxide(s), metal fluoride(s), metal sulfide(s), various other ceramic coatings, polymer(s), and composite(s), to name a few. It is desirable that this material should also be stable in the potential range for the electrode of interest and not undergo undesirable phase transformation reactions.

All layers should be permeable to ion transport in order to provide energy storage capability to the active particles. In some applications, it may be preferred that at least one of the layers does not allow electron transport, thus preventing electrochemical reduction of the aqueous electrolyte on the anode or preventing electrochemical oxidation of the aqueous electrolyte on the cathode. In this case, an electrical insulator of sufficient thickness (e.g., typically greater than about 2-5 nm) should be used to prevent electron tunneling. This function should also be maintained during cycling without forming electron conduction paths by, for example, phase transformation or defect formation.

In some applications, it may be advantageous for the electrode to be filled with a pH-regulating polymer electrolyte or for the most outer layer to contain pH-regulating moieties, thus assisting in preventing aqueous electrolyte decomposition, as described in more detail above.

In some applications, it may be beneficial for some of the coating layer(s) to be deposited on the electrode surface prior to assembling of the cell. In this case, high flexibility can be achieved in both the chemistry and morphology of the layer(s). In some applications, it may be beneficial for at least the outer coating layer(s) to be formed in-situ during the so-called formation cycle(s) of the cell when additive(s) to an aqueous electrolyte decompose at a potential where water does not yet decompose, thus forming a protective coating on the electrode surface. In this case, the overall cost of the cell fabrication can be reduced. In some applications (for example, when multiple protection mechanisms are desired), the coating layer(s) may be deposited both prior to cell assembling and during cycling. The decomposition of electrolyte additives may also provide a protection against defects formed during electrode handling or during cell operation. Such defects ordinarily allow local undesirable water decomposition in some portion of the electrode, leading to self-discharge, gas generation, and cell degradation. The decomposition of the electrolyte additives may “heal” such defects and allow long-term cycle stability to be achieved.

The coating layer(s) on the electrode surface may be deposited by one or more vapor deposition technique(s), including CVD techniques and atomic layer deposition (ALD) techniques, or by electroless deposition, by electrodeposition, by dip coating, by sol-gel, or by other known methods of conformal deposition of coatings.

In some applications, an overall coating thickness (excluding the pH-modifying moieties, if present) in the range of about 2 nm to about 500 nm may be advantageous. Thinner coating may be prone to defects and thus fail to prevent electron tunneling and aqueous electrolyte decomposition. Thicker coatings may impede ion transport or contribute to a significant portion of the total mass or volume, which is undesirable.

In some applications, it may be advantageous for the protective coating to gradually change in composition. In this case, the internal stresses during cycling may be reduced and delamination of the coating prevented.

In some applications, it may be advantageous for the protective coating to contain micropores or mesopores. The presence of such pores may enhance the stability range of aqueous electrolytes. In addition, such pores may accommodate some volume changes within the active material particles, thus stabilizing the mechanical integrity of the electrode during cycling.

Many intercalation-type active materials are compatible with aqueous Li-ion batteries. Examples of such materials include but are not limited to various layered oxide(s), spinel(s), and olivines, to name a few. These include but are not limited to lithium cobalt oxide (LCO), lithium manganese oxide(LMO), lithium nickel manganese cobalt oxide (NMC), lithium iron phosphate (LFP), various other lithium phosphates and fluorophosphates, various lithium metal silicates, and many others. At the same time, many conversion-type active materials offer higher volumetric Li capacities than intercalation compounds. In addition, some of them exhibit a specific Li insertion/extraction potential, which may be advantageous for some applications. They are, however, mostly incompatible with aqueous electrolyte solutions because they either (at least partially) react with water or even (at least partially) dissolve in water (in some stage of charge or discharge). Examples of conversion-type active materials include but are not limited to selenium, lithium selenide, sulfur, lithium sulfide, various metal fluorides (such as copper fluoride, nickel fluoride, iron fluoride, cobalt fluoride, and others), various metal chlorides, various metal bromides, various metal tellurides, various oxides, various nitrides, various phosphides, sulfides, various antimonides, and others. Some other intercalation-type electrodes may similarly exhibit undesirable reactions with aqueous electrolytes, but offer advantages for some applications of aqueous Li-ion cells. Examples of such advantages include a favorable Li insertion/extraction potential, high volumetric or gravimetric capacity, or a high Li insertion rate.

In order to overcome the incompatibility of some favorable active materials with aqueous electrolytes, it may be advantageous in some applications to enclose them in one or more Li-ion permeable, but solvent impermeable protective shell(s).

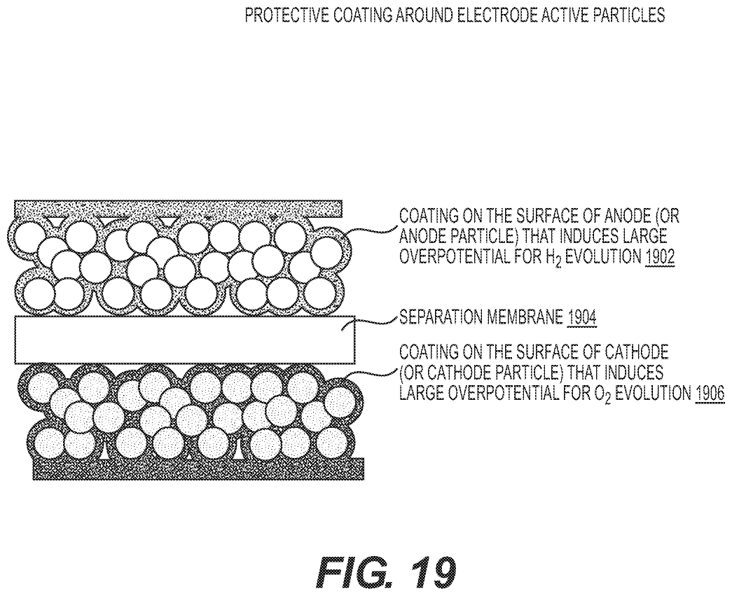

FIG. 19 is a cross-section of an elementary building block comprising an example anode and example cathode for an aqueous Li-ion battery, which comprise metal or metal alloy coatings that induce H₂ overpotential on the anode and O₂ overpotential on the cathode. In the illustrated example, an anode 1902, separator 1904, and cathode 1906 are shown. Examples of suitable metals for the anode include but are not limited to Pb, Cd, Ni, Cu, Fe, Bi, In, Sn, Zn, Ti, Tl, Ta, and selected alloys comprising at least a fraction (e.g., at least 1%) of at least one of these elements. Examples of suitable metals for the cathode include but are not limited to Pb, Cd, Ni, Ti, Ta, Zn, Fe, Co, and selected alloys comprising at least a fraction (e.g., at least 1%) of at least one of these elements.

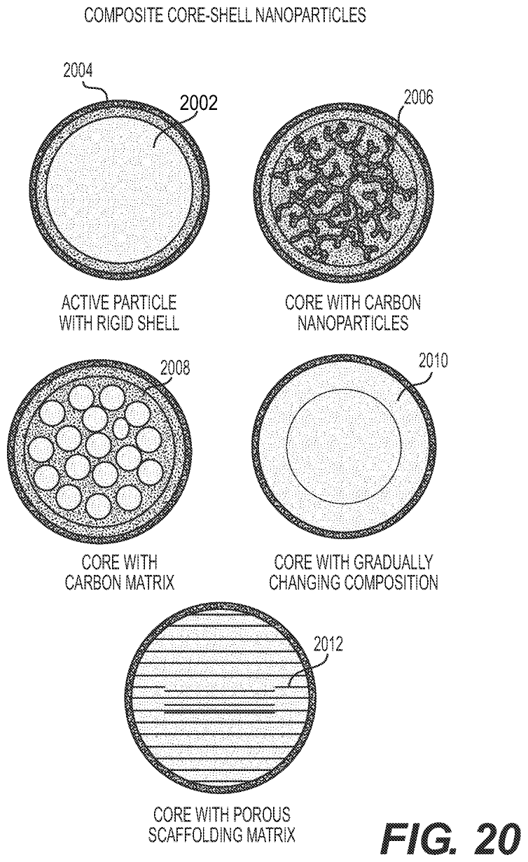

FIG. 20 is a cross-section view of different example particle designs incorporating one or more Li-ion permeable, but solvent impermeable protective shell(s). As shown, each of the example composite core-shell nanoparticles shown here is generally composed of an active core material 2002 (which may comprise Li₂S or other metal sulfides, or other intercalation-type or conversion-type materials capable of storing and releasing Li ions) and a protective shell 2004 that is permeable to Li ions, but not permeable to H₂O. In some particle designs, the core may further include carbon nanoparticles 2006 to enhance electrical conductivity. In some particle designs, the core may further include a carbon matrix 2008 to enhance electrical conductivity. In some particle designs, the shell may be formed with a gradually changing composition 2010 as discussed above. In some particle designs, the core may further include a porous scaffolding matrix 2012 to enhance electrical conductivity, as well as mechanical stability.

In some applications (e.g., when the shells are electrically conductive), it may be advantageous for such shells to be deposited on individual particles prior to electrode assembling. In other applications (e.g., when the shells are electrically insulative or when the shells could be damaged during electrode processing), it may be advantageous for such shells to be deposited after the electrode assembling. In yet other applications, it may be advantageous to deposit the shells at both times, before and additionally after electrode assembling, for example to ensure the lack of water-permeable defects or weak points within shells. The use of many conversion-type active materials (such as metal fluorides, sulfur, selenium, lithium sulfide, or lithium selenide, as a few examples) in aqueous Li-ion battery cells has been conventionally impractical because of their reactivity with (or solubility in) water. However, the above core-shell structure applied to such particles (where shell(s) around the particles prevent water access to the conversion-type active material) may provide unique capabilities to such Li-ion aqueous cells.

Examples of electrically conductive, Li-ion permeable, and water impermeable shell materials include but are not limited to graphitic, disordered, amorphous carbon, various metals, and some conductive ceramic materials. In particular, in some cases, it may be advantageous to use various metals (such as copper, nickel, iron, or bismuth, and the previously described metals that may be utilized as current collectors, to name a few) or various metal alloys as conductive coatings. It may be important, however, to make sure that the deposited metals are further protected against corrosion. It may be further important to make sure that the metal-coated electrodes are not exposed to potentials where undesirable phase transformation may take place. In some applications, it may be advantageous to use conductive polymers (such as polyaniline, for example) as a shell material.

Examples of electrically insulative shell materials include various oxides (such as aluminum oxide, zirconium oxide, silicon oxide, chromium oxide, nickel oxide or various mixed oxides), various fluorides, various sulfides, various mixed ceramics, various polymers, various composites, and others. It may be important to make sure that the electrode is not exposed to the potential where undesirable phase transformation takes place. For example, titanium oxide should preferably not be exposed to a potential below around 1.7 V vs. Li/Li+. It may also be important to make sure that the shell is compatible with the electrolyte employed (e.g., so that it does not dissolve in the electrolyte).

Similar to the protective shell(s) deposited for the purpose of preventing aqueous electrolyte decomposition, the shells deposited to protect the active material from undesirable reactions with water may contain multiple layers. These layers may similarly offer different functions. For example, in addition to protecting the active material from unfavorable interactions with aqueous electrolytes, these shells may provide one or more of the following functions: (i) enhance electrical connectivity between individual active particles; (ii) improve mechanical stability of the active particles; (iii) reduce volume changes within the active particles during cycling; and/or (iv) prevent aqueous electrolyte decomposition at extreme potentials (such as oxygen generation at a high potential of a cathode and hydrogen generation at a low potential of an anode).

As discussed above, one layer may, for example, assist in electrically connecting active particles of the electrode. In this case, the layer should be electrically conductive. Examples of materials for such a layer include but are not limited to a conductive metal coating, which should be stable in the potential range for the electrode of interest. Examples of such a metal suitable for electrodes include but are not limited to Tl, Nb, Hg, Mg, Ti, Ni, Fe, Ta, Sn, Pb, Cd, Zn, Sn, Sb, La, Cr, Bi, or In, or alloys comprising at least a fraction (e.g., at least 1%) of at least one of the above elements. A layer can also be deposited in order to assist in forming uniform coating of a subsequent (e.g., second) layer. Examples of materials for such a layer include but are not limited to metal(s), metal alloy(s), metal oxide(s), metal fluoride(s), metal sulfide(s), various other ceramic coatings, polymer(s), and composite(s), to name a few. It may be important that this material should also be stable in the potential range for the electrode of interest and not undergo undesirable phase transformation reactions. As discussed above, a layer can also be deposited in order to enhance the mechanical properties of the overall coating or enhance the mechanical stability of individual particles. Examples of materials for such a layer include but are not limited to carbon, metal(s), metal alloy(s), metal oxide(s), metal fluoride(s), various other ceramic coating(s), and composite(s), to name a few.

In some embodiments, active cathode particles comprising a conversion-type active material may be used in combination with anode active particles comprising an intercalation-type active material in a construction of aqueous Li-ion cells. In other applications, an intercalation-type active material can be used in the cathode and a conversion-type active material in the anode. In yet other applications, it may be advantageous to use conversion-type active materials for both electrodes or intercalation-type active materials for both electrodes. In still other applications, it may be advantageous to use both types of Li storing materials (intercalation and conversion) in one electrode (for example, when a high capacity conversion-type active material residing in the core of an active particle is surrounded by a lower capacity intercalation-type active material shell that stores Li ions and simultaneously protects the core from unfavorable interactions with an aqueous electrolyte).

All layers with a shell should be permeable to ion transport in order to provide energy storage capabilities to active particles.

In some applications, an overall thickness of the protective shell in the range of about 5 nm to about 500 nm may be advantageous. Thinner shells may be prone to defects. Thicker coatings may impede the ion transport or contribute to a significant portion of the total mass or volume, which is undesirable.

In some applications, it may be advantageous for the protective coating to gradually change in composition. In this case, the internal stresses during cycling may be reduced and delamination of the coating may be prevented or reduced.

In some applications, it may be advantageous for the conformal coating(s) on the electrode surface to both (i) protect some of the active material from reaction with the aqueous electrolyte and (ii) impede or prevent decomposition of the aqueous electrolyte at extreme electrode potentials (that is, prevent oxygen generation on the cathode surface or hydrogen generation on the anode surface). Methods described above may be used to produce pH-regulating layers on the surface of such shells to enhance the aqueous stability range. Similarly, other described methods may be used to deposit layers of electrically insulative (yet Li-ion permeable) material on the surface of such shells to further enhance the stability range of an aqueous electrolyte. Also, other methods described above may be used to deposit layers of materials that induce H₂ overpotential on the anode (preferably in excess of 0.3 V) or O₂ overpotential on the cathode (preferably in excess of 0.3 V).

Various deposition techniques may be used for the conformal formation of layers or complete shells for various implementations described above (such as preventing electrolyte decomposition or preventing various undesirable reactions between the electrolyte and active material, to name a few). Examples include but are not limited to various vapor deposition techniques (such as CVD, ALD, plasma-enhanced CVD, and plasma enhanced ALD, to name a few), various wet chemistry deposition techniques (such as layer-by-layer deposition, dip coating, solution precipitation, sol-gel, electroless deposition, and electro-deposition, to name a few) and other known techniques for the deposition of conformal layers on porous electrode substrates or particles.

For example, for the formation of a nickel metal coating, a CVD method may be used that involves thermal decomposition of a Nickel-biscyclopentadienyl (Nickelocene, Ni(C₅H₅)₂, or NiCp₂) precursor or nickel-carbonyl (Ni(CO)₄) precursor at elevated temperatures (for example, within a temperature range of about 180-250° C.). In some applications (e.g., when a high degree of uniformity is required), it may be advantageous to conduct CVD at reduced pressures (e.g., under vacuum). For the formation of a carbon coating (if the core is thermally stable), a suitable polymer layer may be deposited on the surface of the particles (for example, by a solution precipitation method) and carbonized by annealing at elevated temperature (e.g., above about 400° C.). Alternatively, a CVD method may be employed that involves decomposition of hydrocarbons (such as acetylene) in a gaseous phase at elevated temperature (e.g., above 400° C.). A combination of such methods can also be employed.

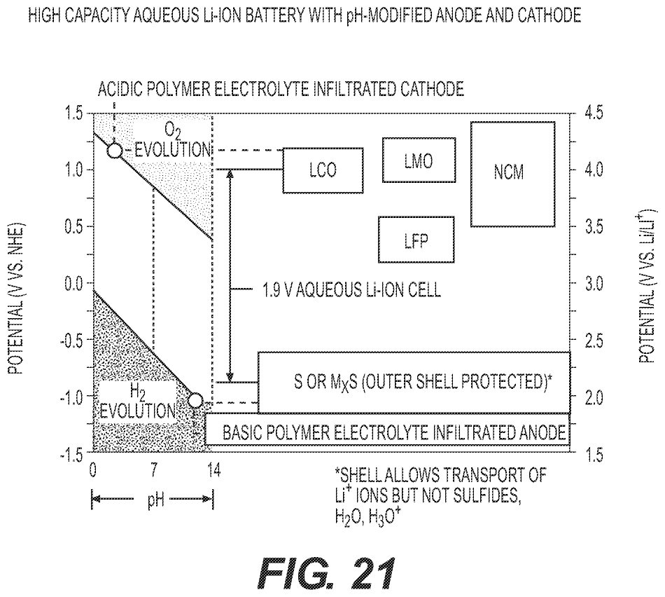

FIG. 21 provides an example of a high capacity aqueous Li-ion battery with a pH-modified anode and cathode. Active cathode particles that comprise one of the common intercalation-type Li-ion storing materials (such as lithium cobalt oxide, LCO, lithium manganese oxide, LMO, or lithium nickel manganese cobalt oxide, NMC, or other Li-ion storing materials) are used in this example cathode embodiment of Li-ion aqueous cells. In some cases (for example, when active particles are designed to have small volume changes during cycling and when their surface is protected from direct interactions with water, as previously described), active anode particles may comprise either conversion-type active material(s) or intercalation-type active materials. In the current example, the anode comprises either (i) environmentally-friendly low-cost sulfur (S)-based core-shell particles that may offer over two times higher volumetric capacity than the graphite currently used in conventional organic Li-ion cells or (ii) metal sulfide particles that exhibit Li intercalation within 1.0-2.9 V vs. Li/Li+ potential range (more preferably within 1.5-2.5 V vs. Li/Li+). Examples of suitable metal sulfides include, but are not limited to: CdS, PbS, MoS₂, ZnS, FeS₂, FeS, In₃S₄, CoS, NiS, CoS₂, Co₃S₄, TiS, TiS₂, TaS₂, Tl₂S, and Tl₂S, to name a few. While some conventional designs have utilized S or Li₂S, or some of the metal sulfides described above comprising active material within a cathode (positive electrode) of a Li-ion or Li cell with an organic or ionic liquid electrolyte, the use of an above-described metal sulfide, shell-protected S, or Li₂S-comprising active material as an anode material with an aqueous electrolyte is unique.

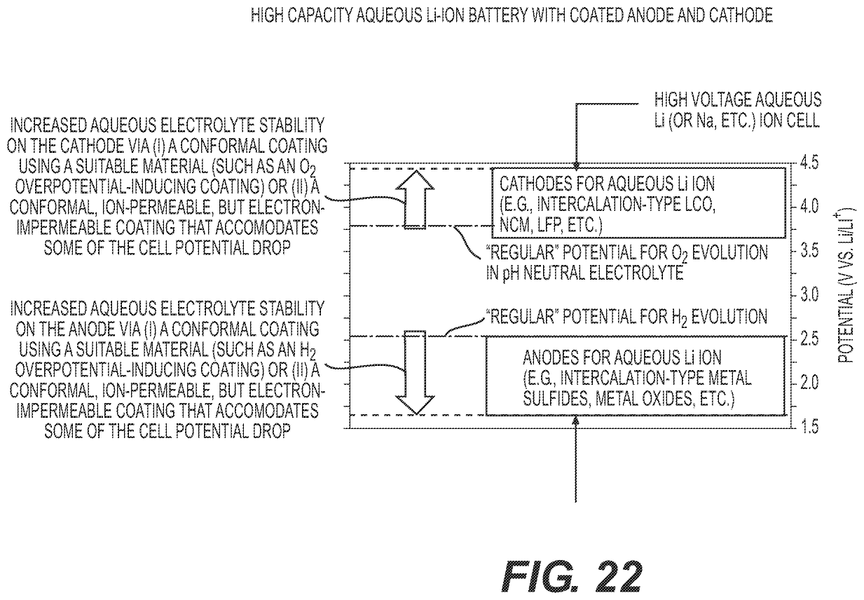

FIG. 22 provides an example of an aqueous Li-ion battery with (i) an anode coated with a material that either induces H₂ overpotential or serves as a thin “solid electrolyte” layer on which some of the potential is dropped and (ii) a cathode coated with a material that induces O₂ overpotential or serves as a thin “solid electrolyte” layer on which some of the potential is dropped.

Many high capacity active materials exhibit significant volume changes during insertion and extraction of Li ions. Such volume changes may induce defects in the functional conformal coatings previously described. Such defects may lead either to the undesirable reaction(s) of the aqueous electrolyte with active material or induce decomposition of the aqueous electrolyte, or both. It is therefore desirable for active particles as a whole to have relatively small volume changes during cycling, and to use such lower volume change particles in the construction of electrodes for aqueous Li-ion cells with enhanced cell voltage.

Accordingly, in various embodiments, each of the active material particles may include internal pores configured to accommodate volume changes in the active material during the storing and releasing of ions. When the active material is a high capacity material that changes volume by more than about 10% during insertion and extraction of ions (e.g., Li⁺, Na⁺, or Mg²⁺ ions), the internal porosity of the active particles can be used to accommodate these volume changes so that charge/discharge cycles do not cause failure of the particle/protective layer interface, and do not induce formation of cracks in the protective layer(s). The overall porosity can be optimized to maximize the volumetric capacity, while avoiding the critical stresses that cause rapid composite failure or fatigue during battery cycling. In some applications, when a relatively brittle protective layer(s) is used or when the interface between the electrode particles and the protective layer(s) is relatively weak, then the presence of internal pores may prove to be beneficial even when the active material changes volume by less than 10%.

Such porous particles may be produced by a so-called “bottom-up” approach, where the particles are built from smaller building blocks. One example to produce such porous active particles is utilization of an emulsion route. For example, active material in the form of nanoparticles can be dispersed in a suitable liquid. Binder (monomer or polymer) to keep the active nanoparticles together can be added to the liquid as well. Another type of additive (conductive particles, for example) can be dispersed jointly with the active material nanoparticles. Then, the suspension of the active particles with the binder may be emulsified in a second liquid immiscible with the first. The size of the porous particle may be controlled by the size of emulsion droplets. The droplets of the emulsion may then be solidified by solvent evaporation or monomer polymerization, yielding porous particles containing pores. In yet another example, porous particles may be produced by a so-called “balling” method, according to which smaller (for example, nanosize) particles are agglomerated together using a binder, which can be removed at later stages or transformed into a solid (e.g., a solid carbon, by carbonization of organic binders). In some examples, the particles can be further annealed in a controlled environment to induce sintering of individual nanoparticles. Another general route to produce such particles is a “top-down” approach where pores are induced in solid particles. In one example, the porous particles can be produced by first forming two or more compound-comprising particles, where one compound is leached out by dissolution or vaporization. In yet another example, porous particles may be produced by partial etching of solid particles.

In some embodiments, it may be advantageous for the active particles with internal porosity and volume-changing active material to be a composite of (i) a conductive material that does not exhibit volume changes (or exhibits very low volume changes) and (ii) volume-changing active material. In some cases, it may be further advantageous for the “low volume change” material to provide a rigid scaffold with internal pores partially filled with a volume changing material. This architecture of the particles allows one to further minimize the volume changes in such composite particles during cycling. Conductive carbon is an example of a material that may be used for such a scaffold.

In some cases (for example, to enhance mechanical stability and reduce the overall volume changes within the nanostructured composite particles filled with a volume-changing material), it may be advantageous for the scaffold material to have gradually increasing volume fraction from the core to the perimeter (surface) of the particles. For the same purpose of increasing mechanical stability, it may be advantageous to have a gradual reduction of the pore size (of the porous scaffold material) from the core to the perimeter of the particles. In some applications, smaller pores near the particle surface may also be easier to coat with a protective shell material, thus providing the additional benefit of simpler and more controlled processing.

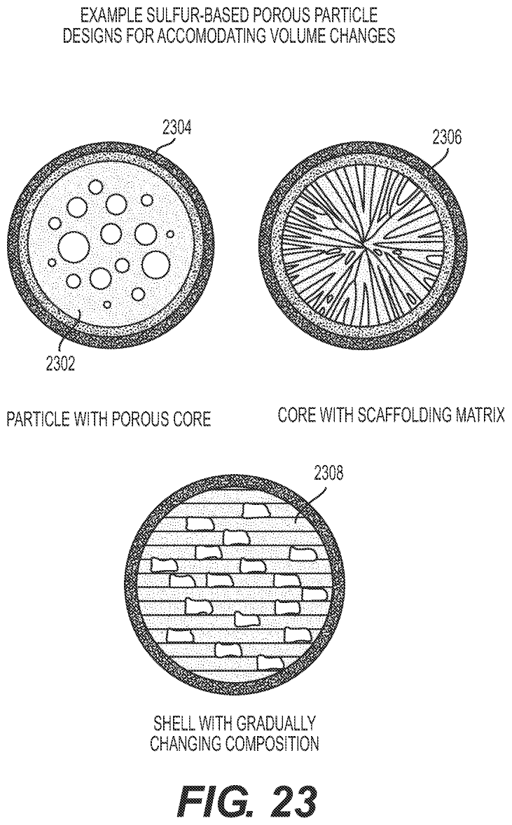

FIG. 23 provides an example of different porous particle designs containing a conversion-type active material (such as sulfur, for example) that experiences volume changes upon Li insertion. As shown, the composite core-shell nanoparticles in this example are generally composed of a porous sulfur (shown by way of example as the active material) core 2302 and a protective shell 2304 permeable to Li ions, but not permeable to H₂O. In some designs, the core may further include a porous scaffolding matrix 2306 to enhance electrical conductivity, as well as mechanical stability. In some designs, the shell may be formed with a gradually changing composition 2308 as discussed above.

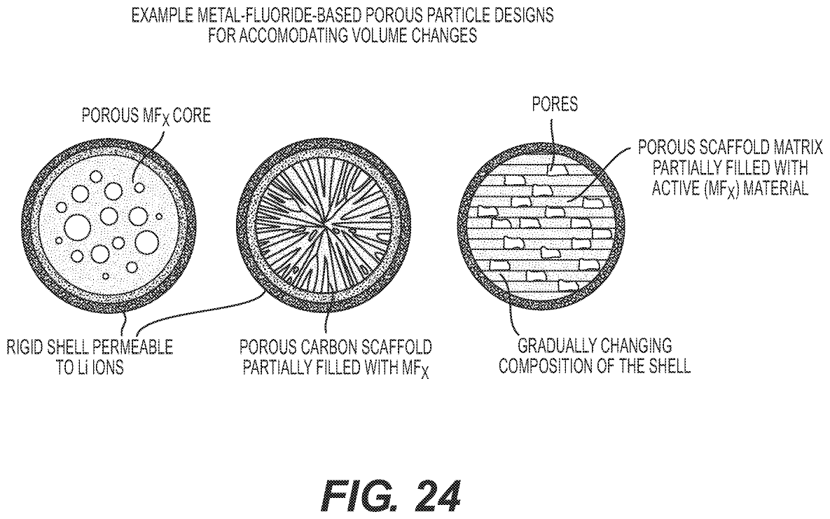

FIG. 24 provides another example of different porous particle designs containing a conversion-type active material (such as metal fluoride, MFₓ, for example) that experiences volume changes upon reaction with Li. In this example, composite core-shell particles are composed of a protective shell permeable to Li ions, but not permeable to H₂O, and a porous carbon scaffold core partially filled with metal fluoride, MFₓ (shown by way of example as the active material). Examples of suitable MFₓ include but are not limited to FeF₂, FeF₃, CoF₂, CoF₃, CuF₂, NiF₂, BiF₂, BiF₃, and various mixed metal fluorides and others. The use of conversion-type active materials in aqueous Li-ion batteries is unique.

In some applications, when using conversion-type volume changing materials that are generally stable in aqueous electrolytes, the use of a similar composite structure with a conductive scaffold may still provide some additional benefits. For example, while iron electrodes are used in commercial iron-nickel “Edison” batteries with an alkaline electrolyte (commonly KOH and LiOH mixture), its capacity utilization is incomplete (often as low as 30% or less, which limits battery energy density), the volume changes are large (which limits stability of a protective coating, if one is applied), and the rate performance is rather poor (which does not allow fast charging and limits the power performance of a cell). Similar limitations are also known for alkaline cells comprising Zn or Cd anodes.

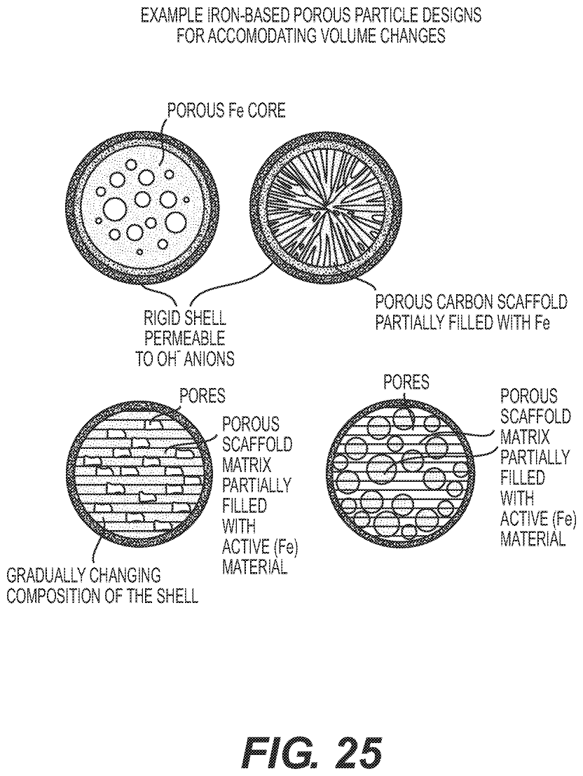

FIG. 25 provides another example of different porous particle designs containing a conversion-type active metal (such as iron (Fe), Zn, or Cd) that experiences volume changes upon reaction with OH⁻ anions. In this example, composite core-shell particles are composed of a protective shell permeable to OH⁻ ions (ideally not permeable to O₂ gas) and a porous metal or porous carbon scaffold core partially filled with Fe (or Zn or Cd, or other suitable materials) particles or Fe (or Zn or Cd, or other suitable materials) layers. Bismuth and bismuth oxides are examples of suitable shell materials for the Fe anode because they inhibit H₂ evolution. In addition, Bi may protect the Fe particles (formed during synthesis) from oxidation in air and formation of inactive Fe₂O₃. Other suitable materials for Fe anodes include, but are not limited to thallium, cadmium, titanium, zinc, tantalum cadmium, lead, tin, niobium and others as well as their oxides and alloys comprising at least a fraction (e.g., at least 1%) of at least one of such materials.

In some embodiments, it may be advantageous for the thickness of the features of the porous scaffold material to be small, e.g., in the range of about 0.3 to about 50 nm in size. Defective fragments of graphene (single or multi-layered with a thickness in the range from 0.3 to 50 nm, for example), activated carbon, carbon nanotubes, graphite ribbons, carbon fibers, carbon black, dendritic carbon particles, templated porous carbon, various porous carbons produced from inorganic precursors (such as carbides or oxycarbides) and various other carbon particles may serve as a scaffold material in some applications. Metal nanoparticles, nanofibers, nanoflakes, porous metal particles, and other materials may also serve as a scaffold material in some applications.

In some applications (for example, when it is important to enhance mechanical properties of the composite particles), it may be advantageous for the porous scaffold material to have a porosity gradually decreasing from the center to the surface of the composite particles.

Similarly, in some applications (for example, when it is important to enhance mechanical properties of the composite particles), it may be advantageous for the volume-changing active material to gradually decrease its volume fraction from the center to the surface of the composite particles.

In some embodiments, it may be advantageous for the porous composite particles to be a nano-composite.

In some embodiments, it may be advantageous for the pores within the active particles to remain small, e.g., in the range of about 0.4 to about 100 nm. This may enhance electronic transport from the conductive porous scaffold to the electrochemical reaction site.

In some embodiments, it may be advantageous for the “nodes” or coatings of the active material deposited within the scaffold to be small, e.g., in the range of about 0.5 to about 500 nm in size (or thickness in case of a coating).

In some embodiments, it may be advantageous for the porous active material (or for the “nodes” of the active material deposited within the scaffold) to contain a secondary protective coating. In this case, if the conformal coating around the particles fails, this secondary coating may provide additional protection against undesirable side reactions with the electrolyte.

In some embodiments, conformal shells around the porous composite particles may serve to prevent volume changes in the porous particles. In some applications, it may be advantageous for the shell to have a gradually changing porosity or gradually changing composition, or both (for example, to minimize stresses occurring during battery cycling and improve stability of the shell-core interface). It may further be advantageous for the shell to gradually emerge from the porous core, again to minimize internal stresses and improve mechanical stability of the composite active particles.

The high rate capability of an aqueous electrolyte can reduce the overall heating caused during use. In addition, high temperature performance will not cause significant irreversible degradation in an aqueous electrolyte. As such, battery structures provided herein require little or no cooling system. Because of the inherent safety of the cell, conventional packaging used to make battery modules and packs can be reduced, as they are no longer needed to serve the same protective role. Instead, the battery module and packs can be used (e.g., in electric vehicle applications) to protect passengers and absorb the energy of impact in the case of a severe crash (the electrolyte is safe). This may further improve the system-level performance of the provided energy storage solution based on a pH neutral electrolyte.

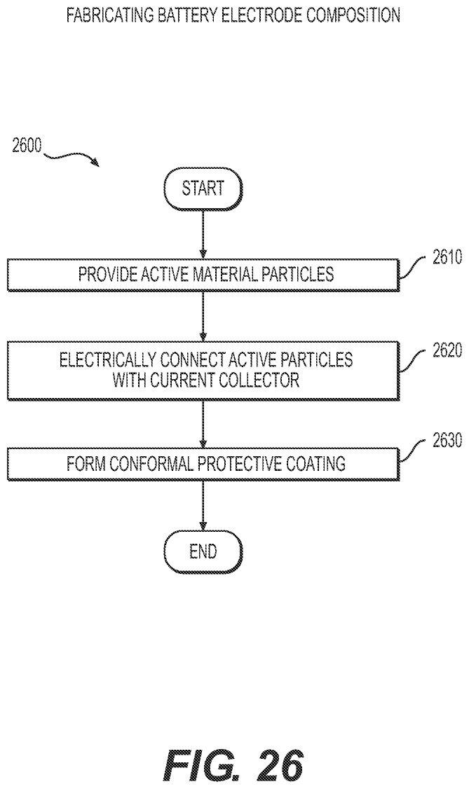

FIG. 26 is a flow chart illustrating an example method of fabricating a battery electrode composition comprising active particles. As shown, the method 2600 may comprise, for example, providing active material particles to store and release ions during battery operation (block 2610) and electrically connecting the active particles with a current collector (block 2620). A conformal protective coating may then be formed on the electrode surface in such a way that the electrode remains porous while all (or at least a significant portion) of its open pore surface area is covered with such a coating (block 2630).

For connecting the active particles together during the electrode fabrication, the method may utilize a mixing process for mixing the active particles with a binder and an annealing process for annealing at an elevated temperature to cause solidification of the bonded particles in a particular shape. In some embodiments, the surface of the active particles may allow sintering particles together at elevated temperatures and thus not require a binder. In some embodiments, the surface coating of the active particles may deform during sintering or electrode preparation (e.g., during annealing or during application of a mechanical pressure) in such a way as to have a significantly smaller coating thickness in the areas where particles touch each other. This may be advantageous, for example, when the coating is electrically isolative, because in the particle-to-particle contact points a significantly thinner coating may provide, for example, paths for electron transport (for example, via quantum mechanical tunneling). In some applications, the electrode surface may be additionally coated with at least one layer of electrically conductive material.

As discussed above, in some embodiments, the coating, the shell, or the particles themselves may have a gradually changing composition. This may be achieved, for example, by gradually changing the composition of the coating precursor. In contrast to traditional Li-ion batteries, aqueous Li-ion conducting cells can be manufactured in a small, commodity, cylindrical form factor, which may be advantageous for electric vehicle applications. For example, such a multi-cell battery can be designed to have a shape that fits the space available, rather than building the car around a large prismatic design. Small cylindrical cells using steel casings can be used to provide tremendous rigidity to the module and pack, and in turn carry loads normally borne by the chassis. With traditional Li-ion cells, such an approach would never be used, since damaging the cells in an accident would lead to nearly certain thermal runaway. This approach, however, is made feasible by the aqueous Li-ion conducting cells disclosed herein.

In some embodiments, it may be advantageous for the thicker electrodes of aqueous batteries to contain pores (for example, pores perpendicular to the electrode surface) to provide channels for faster electrolyte ion diffusion through the electrode. The pore width may range, for example, from as little as about 20 nm to as much as about 500,000 nm (0.5 mm). This structure of the porous electrode may be particularly advantageous if the electrode thickness is in the range of about 0.2 mm to about 5 mm. In this case, having the “channel” pores within the electrode may significantly enhance the rate or power performance of the disclosed aqueous batteries.

In some embodiments (particularly if the protective conformal coating is applied to the whole electrode), it may be advantageous for the electrodes of aqueous batteries to be composed of multiple individual, separate segments, each connected to the current collector. In this case, if the protective coating breaks on one of the segments of the electrode, other segments will not be affected. In some applications, it may be advantageous to have the volume of each segment be no more than 1 mm³. For example, if the electrode is 1 mm thick, each segment may be of rectangular shape with a cross-sectional area of less than 1 mm².

In some embodiments, it may be advantageous to embed a porous metal (e.g., a metal or conductive carbon foam or mesh) current collector within the electrode. In this case, both mechanical properties of the electrode and electrical conductivity of the electrode will be enhanced. It is noted, however, that in some embodiments (e.g., in cases when the metal current collector does not exhibit high overpotential for water decomposition), it may be advantageous to deposit a conformal protective coating on all of the open internal surface area of the electrode, including the current collector.

Compared to conventional Li-ion batteries, the dramatic cost reduction of the provided aqueous Li-ion technology also comes from different manufacturing technology that may be facilitated by the significantly higher ionic conductivity of aqueous Li-ion electrolytes. Because aqueous electrolytes offer higher conductivity than those based on the carbonate solvents used in commercial Li-ion cells, the electrodes can be made about 0.5-5 millimeters thick while maintaining acceptably high power characteristics. This is because high electrical conductivity is relatively straightforward to maintain and because relatively slow (e.g., less than around “2C”) charging rate in graphite anode-based commercial Li-ion cells is limited by the low solid electrolyte interphase stability, high charge-transfer resistance, and Li plating (due to low lithiated graphite potential). All these factors disappear or become greatly reduced (charge transfer resistance) in aqueous Li-ion systems. As a result, with thick electrodes, bulk (molding) rather than surface (coating) manufacturing methods may be used in some embodiments of aqueous Li-ion batteries. In some applications, it may be advantageous to use a process that is akin to alkaline batteries rather than traditional Li-ion cells.

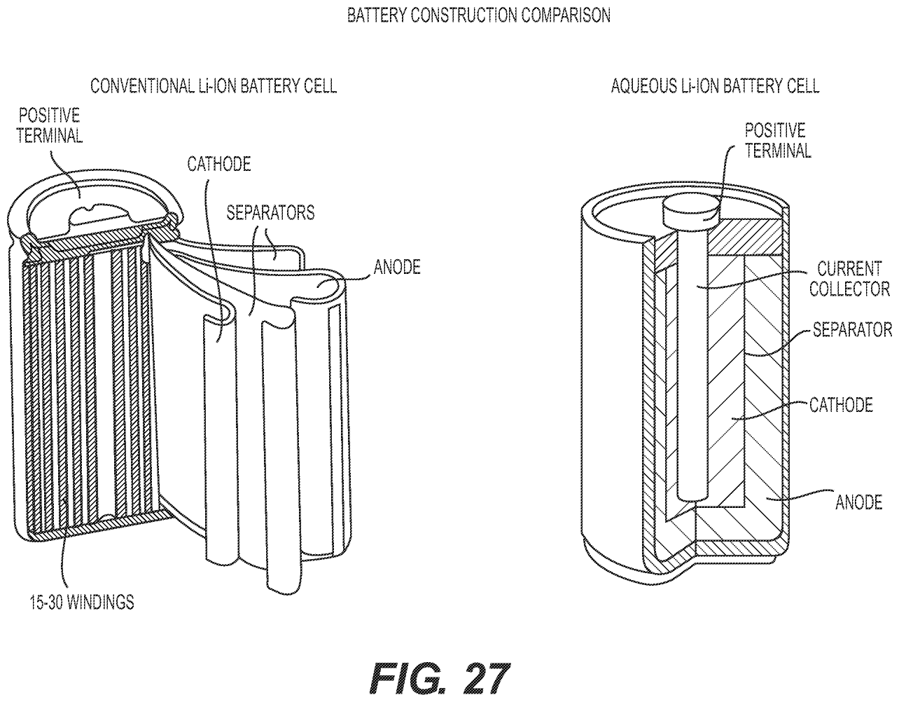

FIG. 27 shows a comparison of two cell constructions, including a conventional Li-ion cell side by side an aqueous Li-ion cell as described herein. A traditional Li-ion cell in a cylindrical 18×65 mm case utilizes anywhere from 15 to 30 winds of a very thin electrode to occupy that volume. In order to create the winding, great care is taken to cast the active material onto thin copper and aluminum foils which are then sliced into sections nearly three feet long, stacked with two separators, and wound with extreme precision to ensure all edges are aligned. Any misalignment or variation in the amount of active material along the three-foot foil can lead to electrical short circuits and thermal runaway. As a result, these processes require extremely high precision and many additional quality control steps which result in a relatively high cost of assembly.

There are also technical limitations in this process. For example, the minimum thickness of Cu and Al that must be used to keep from tearing during assembly is approximately 10 μm. Much of this foil, however, is unnecessary from an electrical conductivity standpoint, adding little to the performance of the cell other than allowing for robust assembly. The copper and aluminum conductors in a cell make up 5 g of a 45 g cell, or about 11% of the total mass. The separator, while light, takes up 7% of the volume. The case adds 12-14% by volume and 10% by mass. Much of this is essentially dead weight, as well as dead volume and unnecessary cost, which are compared below.

This conventional construction methodology leaves only 60-65% of volume available for the functional active electrodes in the cell. The reason for this complexity and inefficiency stems directly from the need to keep electrode thicknesses at or below 100 μm to allow sufficient ionic conductivity in the electrode during operation. The need for electric vehicles, for example, to operate at low temperatures exaggerates these limitations even further, as the ionic conductivity of the commercial organic electrolytes often drops tenfold when operating at −20° C. Finally, due to the high sensitivity of cell performance to moisture residues, extensive drying and expensive glovebox-operated electrolyte filling/sealing protocols must be employed.

In contrast, assembly for the provided aqueous Li-ion technology is dramatically simpler. As in alkaline cells, a cylindrical pellet of anode material may be prepared, typically about 0.5-8 mm thick depending on the diameter of the battery and the rate performance desired, and inserted into the casing from the open top end. The pellet is electrically conducting and free standing, and makes contact with the casing, which serves as a current collector and negative terminal for the cell. Next, a cylindrical separator is inserted, after which a cylindrical cathode pellet, followed by the addition of the electrolyte, the top cap, and the positive electrode pin (which occupies the same space and doubles up functionally for the traditional central vent tube). Once firmly pressed, the cell is crimped in a manner similar to conventional cells.

Unlike conventional Li-ion cells, however, the entire process can take place in a humid environment and does not require the construction of expensive dry rooms. The simple construction is not only cheaper and faster to manufacture, but carries additional safety benefits and enhanced process robustness. In traditional Li-ion construction, the separator spans nearly three feet, and two layers are required for the winding. As a result, engineers have pushed the separator to be as thin as possible to minimize its inactive volume—anywhere from 16-25 μm in typical cells. This, however, reduces the safety of the cell, as the thinner separators are more susceptible to internal short circuits due to defects, particulate contaminants, and dendrites. A penetration through the separator during charging is a common cause of sudden thermal runaway in Li-ion systems. To combat the problem, automotive cells use thicker separators—typically, 25 μm and thicker—but this reduces the energy density of their cells and increases the $/kWh cell costs. In the construction provided herein, however, the separator length may be made less than about 1/20^{th} of that in a conventional cell, and can therefore be made thicker to improve safety and eliminate unwanted internal short circuits with minimal impact on cost or energy density.

In contrast to traditional alkaline cells, in some embodiments, it may be advantageous to use more than one positive or more than one negative electrode in the construction of the aqueous Li-ion cells. In this case, the thickness of each electrode may be kept relatively small (for example, about 0.2-1 mm), while the overall power performance may be high, allowing fast charging (within an hour or faster) in cells with a relatively large diameter of more than 10 mm.

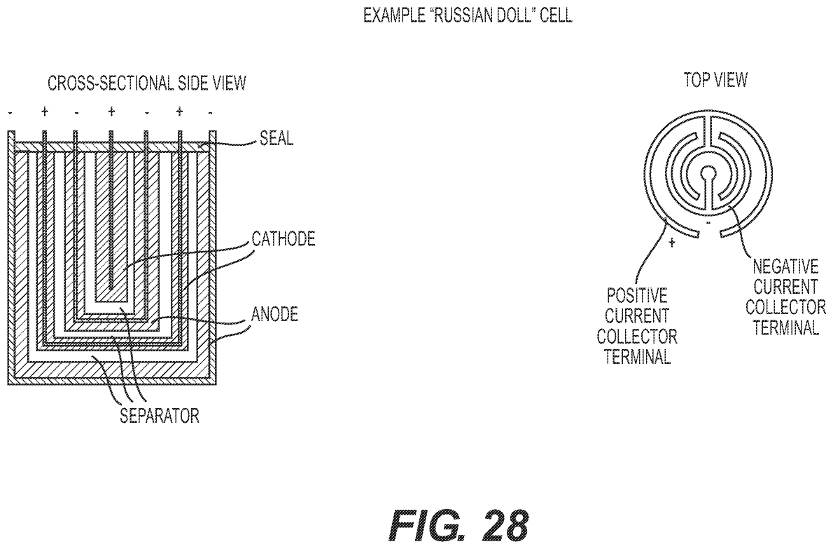

FIG. 28 shows an example of such a cell, where positive and negative electrodes are of cylindrical shape, are separated by a separator membrane material, and are inserted into each other in a manner similar to “Russian dolls”.

In some embodiments, it may be advantageous to produce planar cells, instead of cylindrical cells. In this case, cells may be packed together more efficiently, providing less “free volume” space between individual cells.

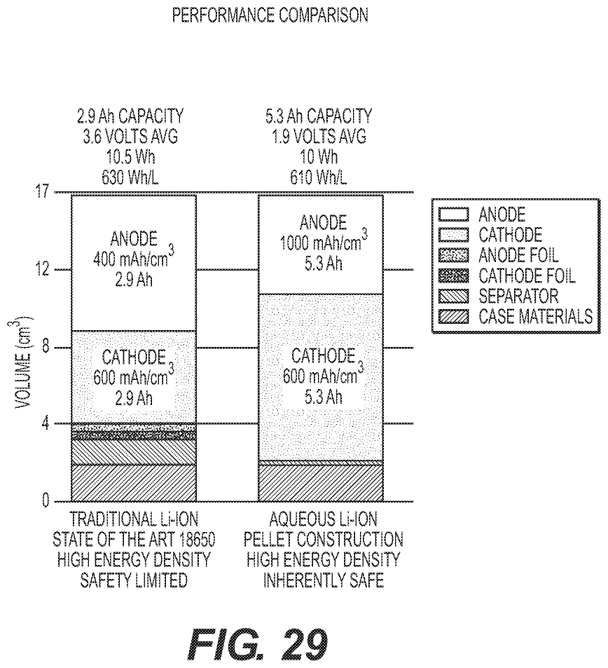

FIG. 29 shows select performance characteristics of two example cell constructions, including a conventional Li-ion cell side by side an aqueous Li-ion cell as described herein. Deconstruction of a mass-produced, 2.9 Ah, 3.6 V traditional Li-ion cell showed the anode and cathode capacity with a volumetric capacity to be 400 and 600 mAh/cc, respectively. Because certain example embodiments may utilize a similar, traditional cathode with a surface modification technique, they may also reach 600 mAh/cc in well-designed cells. Capacity of pure Li₂S is 1,931 mAh/cc. Conservatively assuming that 48% of the volume will be occupied by the non-active components and pores, it can be estimated that the protected S-based anode capacity may approach 1,000 mAh/cc for this example of an aqueous Li-ion cell. Since a different manufacturing technology can be employed for the fabrication of aqueous Li-ion cells, the volume occupied by the separator may be reduced, and the Al and Cu foils may be eliminated. As a result, for an 18650-volume-equivalent aqueous Li-ion cell with such 1000 mAh/cc anode and 600 mAh/cc cathode, it may be estimated that a 5.3 Ah capacity may be achieved, along with an average voltage of, for example, 1.9 V, and an energy density of 610 Wh/L (200 Wh/kg). This is around 90% of traditional high energy Li-ion cells, but at substantially lower cost.

The forgoing description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A battery electrode composition for use in aqueous electrolytes, comprising:
a current collector;
active particles electrically connected to the current collector, wherein the active particles are provided to store and release metal ions of an active material during battery operation; and
a conformal, metal-ion permeable coating that at least partially encases the surface of the connected active particles, whereby the conformal, metal-ion permeable coating impedes (i) direct electrical contact of an aqueous electrolyte with the active particles and (ii) aqueous electrolyte decomposition during battery operation.

2. A method of fabricating an aqueous metal-ion battery electrode composition, comprising:
providing active particles to store and release metal ions of an active material during battery operation;
electrically connecting the active particles with a current collector; and
forming a conformal, metal-ion permeable coating so as to at least partially encase the surface of the connected active particles.
